(19) United States
(12) Patent Application Publication
(10) Pub. No.: US 2024/0037158 A1
(43) Pub. Date: Feb. 1, 2024

(54) METHOD TO CLASSIFY COMPLIANCE PROTOCOLS FOR SAAS APPS BASED ON WEB PAGE CONTENT

(71) Applicant: Palo Alto Networks, Inc., Santa Clara, CA (US)

(72) Inventors: Sheng Yang, Santa Clara, CA (US); William Redington Hewlett II, Mountain View, CA (US); Manish Mradul, Milpitas, CA (US); Sanchita Dutta, Union City, CA (US)

(21) Appl. No.: 17/877,199

(22) Filed: Jul. 29, 2022

(51) Int. Cl. G06F 16/951; G06F 16/955; G06F 16/954; G06N 3/02

(52) U.S. Cl. CPC G06F 16/951; G06F 16/955; G06F 16/954; G06N 3/02

(57) ABSTRACT

The present application discloses a method, system, and computer system for automatically detecting protocol compliance of applications. The method includes determining a URL of a webpage for a software-as-a-service (SaaS) product, extracting body text from the webpage, and using a classifier to determine whether the SaaS product is compliant with one or more protocols.

### BACKGROUND OF THE INVENTION

Applications, such as enterprise applications or other software-as-a-service (SaaS) products, are increasingly being implemented by organizations. As organizations grow or become more complex the set of applications used in the enterprise generally increases. At scale, organizations have numerous applications which are oftentimes provided by different vendors.

Organizations generally classify the applications by performing a manual review of the product specifications, support documentation, or web resources (e.g., publicly exposed websites) pertaining to the applications. For example, an organization may be interested in determining whether a particular SaaS product is compliant with a protocol such as General Data Protection Regulation (GDPR). A human thus is tasked with reviewing the product specifications, support documentation, or web resources pertaining to the applications to determine whether the application is compliant with the protocol.

### BRIEF DESCRIPTION OF THE DRAWINGS

Various embodiments of the invention are disclosed in the following detailed description and the accompanying drawings.

FIG. 1 is a block diagram of an environment in which a product compliance is automatically detected according to various embodiments.

FIG. 2 is a block diagram of a system for detecting whether a product is compliant with one or more protocols according to various embodiments.

FIG. 3 is a block diagram of a process for detecting whether a product is compliant with one or more protocols according to various embodiments.

FIG. 4A is an illustration of a process for obtaining a compliance score with respect to compliance of a product with respect to one or more protocols according to various embodiments.

FIG. 4B is an illustration of a process for obtaining a compliance score with respect to compliance of a product with respect to one or more protocols according to various embodiments.

FIG. 5 is a flow diagram of a method for determining whether a product is compliant with one or more protocols according to various embodiments.

FIG. 6 is a flow diagram of a method for determining a risk score for a product based on compliance with one or more protocols according to various embodiments.

FIG. 7 is a flow diagram of a method for determining a model for detecting whether a product is compliant with one or more protocols according to various embodiments.

FIG. 8 is a flow diagram of a method for determining a risk score for a product based on compliance with one or more protocols according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a feature may include a measurable property or characteristic manifested in input data, which may be raw data. As an example, a feature may be a set of one or more relationships manifested in the input data. As another example, a feature may be a set of one or more relationships between text and a product or application, between text and compliance of a product/application with one or more protocols, etc.

As used herein, a security entity may include a network node (e.g., a device) that enforces one or more security policies with respect to information such as network traffic, files, parked domains, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, malware (or also referred to herein as malicious samples or malicious files) may include an application that engages in behaviors, whether clandestinely or not (and whether illegal or not), of which a user does not approve/would not approve if fully informed. Examples of malware include trojans, viruses, rootkits, spyware, hacking tools, keyloggers, etc. One example of malware is a desktop application that collects and reports to a remote server the end user's location (but does not provide the user with location-based services, such as a mapping service). Another example of malware is a malicious Android Application Package .apk (APK) file that appears to an end user to be a free game, but stealthily sends SMS premium messages (e.g., costing $10 each), running up the end user's phone bill. Another example of malware is an Apple iOS flashlight application that stealthily collects the user's contacts and sends those contacts to a spammer. Other forms of malware can also be detected/thwarted using the techniques described herein (e.g., ransomware). Further, while malware signatures are described herein as being generated for malicious applications, techniques described herein can also be used in various embodiments to generate profiles for other kinds of applications (e.g., adware profiles, goodware profiles, etc.).

As used herein, a model includes a machine learning model and/or a deep learning model. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

Information technology (IT) software applications have moved to a software-as-a-service (SaaS) business model at a rapid pace. Although adoption of a SaaS product (e.g., a SaaS services or SaaS application) gives users best in class application experience along with ease of use and collaboration opportunities, it also introduces security and compliance challenges. Adoption of SaaS products moves enterprise data from corporate networks to SaaS application data centers, which can result in audit, compliance, and control capability gaps for corporations with respect to the corporation's data and/or customer data.

A SaaS application service could be compliant with one or more protocols (e.g., a legal compliance or technical compliance, etc.). Some well-known compliance protocols are General Data Protection Regulation (GDPR), Health Insurance Portability and Accountability Act (HIPAA), and Control Objectives for Information and Related Technology (COBIT). The compliance protocols require companies to maintain a full understanding of the regulatory requirements. A service can provide organizations with information about the SaaS products deployed on their enterprise networks or otherwise used by the organization's employees. For example, a service can provide an indication to organization of whether one or more SaaS products are compliant with one or more (or even many) protocols. Determination, or identification, of whether a SaaS product is compliant with one or more protocols can assist with identifying corporate risks, such as risks associated with putting corporate information into SaaS products. Related art systems use human users to manually check different compliance protocols for each SaaS application. Such manual review and analysis of protocol compliance is not feasible at scale. For example, thousand, or tens of thousands of SaaS products are deployed.

According to various embodiments, a model (e.g., a machine learning model, a neural network model, etc.) is used in connection with determining whether a particular SaaS product is compliant with one or more protocols. The model can make a prediction of whether the SaaS product is compliant with one or more protocols. The prediction of whether the SaaS product is compliant can be made based on information included on a webpage for the SaaS product. In some embodiments, the system determines a risk score based at least in part on a determination of whether the SaaS product is compliant with the one or more protocols. The risk score can be determined according to a predefined algorithm, such as a weighted average of individual risk scores respectively determined for each of the one or more protocols. The system handles the SaaS product (e.g., traffic flowing between the SaaS product and the enterprise network) based on the determination of whether the SaaS product is compliant with one or more protocols. The one or more protocols with respect to which the SaaS product is analyzed can be configurable such as based on an administrator setting, a customer/company/organization preference, etc. In some embodiments, in response to determining that the SaaS product is not compliant with one or more protocols, the system performs an active measure. Examples of active measures include (i) providing an indication to a user such as an administrator for a company/organization network, (ii) blocking traffic to/from the SaaS product, (iii) updating a mapping of a blacklist of SaaS products or traffic, and (iv) providing a recommendation of an alternative SaaS product that is compliant with the one or more protocols, etc.

Various embodiments include a system, method, and/or device for automatically detecting protocol compliance of applications, such as software-as-a-service (SaaS) products. The system comprises one or more GPU/CPU processors and a memory. The one or more processors are configured to (i) determine a URL of a webpage for a software-as-a-service (SaaS) product, (ii) extract body text from the webpage, and (iii) use a classifier to determine whether the SaaS product is compliant with one or more protocols based at least in part on the body text. The classifier may be a model, such as a text Convolutional Neural Network (CNN) model.

Various embodiments include a system, method, and/or device for training a model for automatically detecting protocol compliance of applications. The system comprises one or more processors and a memory. The one or more processors are configured to (i) generate label data for training a machine learning model to detect software-as-a-service (SaaS) product compliance with one or more protocols, (ii) train the machine learning model based at least in part on the label data, (iii) deploy the machine learning model. The determining the plurality of models to build may comprise using the dataset format information to identify the plurality of models. Although the foregoing described training a machine learning model, a deep learning model may be similarly trained.

Examples of protocols include: GDPR, HIPAA, International Traffic in Arms Regulations (ITAR), ISO 9001, Financial Industry Regulatory Authority (FINRA), COBIT, Family Educational Rights and Privacy Act (FERPA), Federal Financial Institutions Examination Council (FFIEC), ISO 27002, Jerico Forum Commandments, ISO 27001, (COPPA), (GLBA), ISAE 3402, (PCI), PrivacyMark (e.g., a Japanese protocol), FedRamp, Sarbanes-Oxley Act (SOX), Cloud Security Alliance Security Trust Assurance and Risk (CSA STAR) Self-Assessment, Safe Harbor, (FISMA), Generally Accepted Privacy Principles (GAPP), C5 (e.g., a German protocol), Statement on Standards for Attestation Engagements no. 18 (SSAE 18), NIST SP 800-53, ISO 27017, HITRUST CSF, Privacy Shield, TrustArc, ISO 27018, System and Organization Controls 1 (SOC1), System and Organization Controls 2 (SOC2), Criminal Justice Information Services (CJIS). Various other protocols may be implemented.

In some embodiments, in response to determining that a SaaS product is to be assessed for compliance with respect to one or more protocols, the system performs a web search for one or more webpages pertaining to the SaaS product. For example, the system sends a query to a search engine (e.g., Microsoft® Bing, Google®, Yahoo! ®, DuckDuckGo, etc.) for the SaaS protocol. The query can include an indication of the SaaS product (e.g., a product name, product URL, a product version, domain of product or service provider, etc.) and at least one of the protocols with which compliance is to be assessed. The system can use a set of queries respectively corresponding to different protocols to discover webpages pertaining to the SaaS product compliance with respect to the different protocol. The system receives a set of results for the query to the search engine. The set of results includes a set of URLs for various webpages.

In some embodiments, in response to receiving the set of results for the query to the search engine, the system filters the set of results to obtain a relevant webpage(s). The system extracts information from the relevant webpage(s) and uses a classifier to analyze at least the relevant webpage(s) in connection with predicting whether the corresponding SaaS product is compliant with the protocol with which the relevant webpage(s) is associated.

The system can use the search engine to identify and provide required metadata/properties from SaaS provider vendor's publicly listed documentation, which will be utilized by a machine learning model to make a determination of whether the SaaS product is compliant with one or more protocols.

According to various embodiments, the system extracts content from a webpage for a SaaS product and uses the content to determine one or more feature vectors to be used by a classifier (e.g., the model) in connection with determining whether the SaaS product is compliant with one or more protocols. The content extracted from the webpage may be body text. The system determines one or more characteristics associated with the content included in the webpage such as a number of external links, an external link ratio, an amount of text, a ratio of link text to total text, an indication of whether at least part of the content matches one or more predefined regexes or other signatures or patterns, etc. The system may determine at least a subset of the one or more feature vectors based at least in part on the one or more characteristics associated with the content included in the webpage. In some embodiments, the system filters the one or more characteristics to obtain a filtered set of characteristics. The filtering of the one or more characteristics includes filtering out characteristics that are not unique to SaaS products that are not compliant with a particular protocol. In response to obtaining the filtered set of characteristics, the system determines the one or more features.

In some embodiments, the system obtains the content from the webpage for a particular SaaS product from rendered HTML data for the webpage. For example, the system obtains the content from the rendered HTML data in the case that the determination of whether a SaaS product is compliant with a particular protocol is performed on a server, such as a remote server queried by a security entity, a client running on a client system, etc.

In some embodiments, the system obtains the content from the webpage for a particular domain from raw HTML data for the webpage. For example, the system obtains the content from the raw HTML data in the case that the determination of whether a SaaS product is compliant with a particular protocol is performed in-line with processing of traffic (e.g., processing requests to access domains). As an example, the content is obtained from the raw HTML data by a security entity (e.g., a firewall that detects parked domains in-line with the processing of traffic) or a client running on a client system.

According to various embodiments, the system for detecting compliance of SaaS products with respect to one or more protocols is implemented by one or more servers. The one or more servers may provide a service for one or more customers and/or security entities. For example, the one or more servers detect compliant SaaS products (or traffic to/from compliant or non-compliant SaaS products) and/or determine/assess whether a particular SaaS product is compliant with one or more protocols, and provide an indication of whether the SaaS product (or set of SaaS products used by user of an organization) to the one or more customers and/or security entities. The one or more servers provide to a security entity the indication that a SaaS product is compliant/non-compliant in response to a determination of whether the SaaS product is compliant with one or more protocols, and/or in connection with an update to a mapping of SaaS products to indications of whether the SaaS product is compliant with a particular protocol(s) (e.g., an update to a blacklist comprising identifier(s) associated with the SaaS products). As another example, the one or more servers determine whether a SaaS product is compliant with one or more protocols in response to a request from a customer or security entity for an assessment of whether the SaaS product is compliant, and the one or more servers provide a result of such a determination. In some embodiments, in response to determining that a particular SaaS product is compliant with a particular protocol, the system updates a mapping of representative information/identifiers of SaaS products to protocols with which a corresponding SaaS product is compliant (or alternatively, non-compliant) to include a record or other indication that the SaaS product is compliant (or alternatively, non-compliant). The system can provide the mapping to security entities, end points, etc.

In some embodiments, the system receives historical information pertaining to a whether a SaaS product is compliant with a protocol(s) (e.g., historical datasets of compliant SaaS products and/or historical datasets of SaaS products that are deemed to be non-compliant) from a third-party service such as VirusTotal® or from an administrator (e.g., such a dataset being manually labeled/generated, etc.). The third-party service may provide a set of SaaS products deemed to be compliant with a particular set of protocols, and a set of SaaS products deemed to be non-compliant with the particular set of protocols. As an example, the third-party service may analyze the SaaS product (e.g., a webpage for the SaaS product) and provide an indication whether the SaaS product is compliant with a protocol, and/or a score indicating the likelihood that the SaaS product is compliant with the protocol. The system may receive (e.g., at predefined intervals, as updates are available, etc.) updates from the third-party service such as with newly identified SaaS products, corrections to previous misclassifications, etc. In some embodiments, an indication of whether a SaaS product in the historical datasets is compliant with a particular protocol corresponds to a social score such as a community-based score or rating (e.g., a reputation score) indicating that a SaaS product is compliant or non-compliant, likely to be a compliant or non-compliant, is received. The system can use the historical information in connection with training the classifier (e.g., the classifier used to determine whether a SaaS product is compliant with a particular protocol).

According to various embodiments, a security entity and/or network node (e.g., a client, device, etc.) handles traffic (e.g., domain access requests, an input string, a file, etc.) based at least in part on an indication that the SaaS product is compliant or non-compliant and/or that the SaaS product (e.g., traffic for the SaaS product) matches a SaaS product indicated to be a compliant or non-compliant, as applicable. In response to receiving an indication that the traffic is for a non-compliant SaaS product, the security network and/or network node may update a mapping of SaaS products to an indication of whether the corresponding SaaS product is non-compliant with respect to a particular protocol, and/or a blacklist of SaaS products.

Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies. The set of rules or policies can indicate that traffic for non-compliant SaaS products, or SaaS products deemed to be risky (e.g., a risk score that exceeds a risk threshold), is to be blocked, etc.

Security entities or devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first-generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless, and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provides higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' PA Series next generation firewalls, Palo Alto Networks' VM Series firewalls, which support various commercial virtualized environments, including, for example, VMware® ESXi™ and NSX™, Citrix® Netscaler SDX™ KVM/OpenStack (Centos/RHEL, Ubuntu®), and Amazon Web Services (AWS), and CN Series container next generation firewalls, which support various commercial container environments, including for example, Kubernetes, etc.). For example, virtualized firewalls can support similar, or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

According to various embodiments, the system for detecting an exploit (e.g., a parked domain) is implemented by a security entity. For example, the system for determining whether a SaaS product is compliant with one or more protocols or whether traffic is for a compliant or non-compliant SaaS product, is implemented by a firewall. As another example, the system for determining whether a SaaS product is compliant with one or more protocols or whether traffic is for a compliant or non-compliant SaaS product as an anti-malware or other security application running on a device (e.g., a computer, laptop, mobile phone, etc.), such as a managed device of an organization. In some embodiments, the system for determining whether a SaaS product is compliant with a particular protocol, or set of protocols, is at least partly implemented by a security entity. For example, the security entity can analyze network traffic based at least in part on a blacklist of non-compliant SaaS products, a whitelist of compliant SaaS products, or a model to detect whether a SaaS product is compliant/non-compliant, and forward to another entity (e.g., a remote server such as in the cloud) network traffic deemed to be for non-compliant SaaS products for a determination/confirmation of whether a SaaS product is compliant.

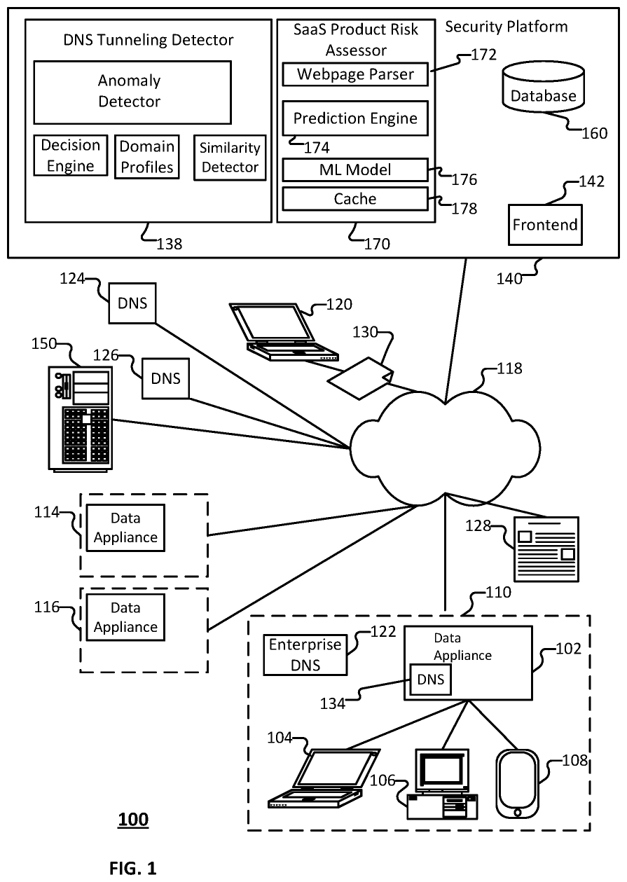

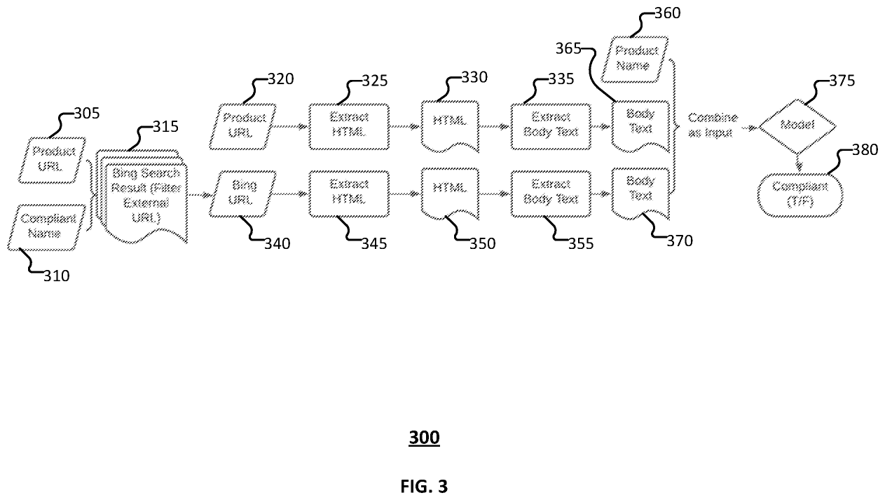

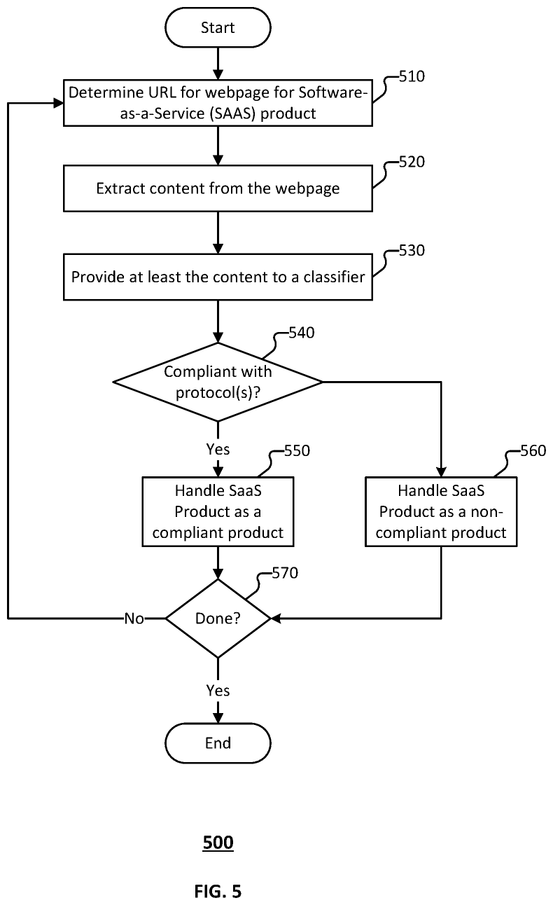

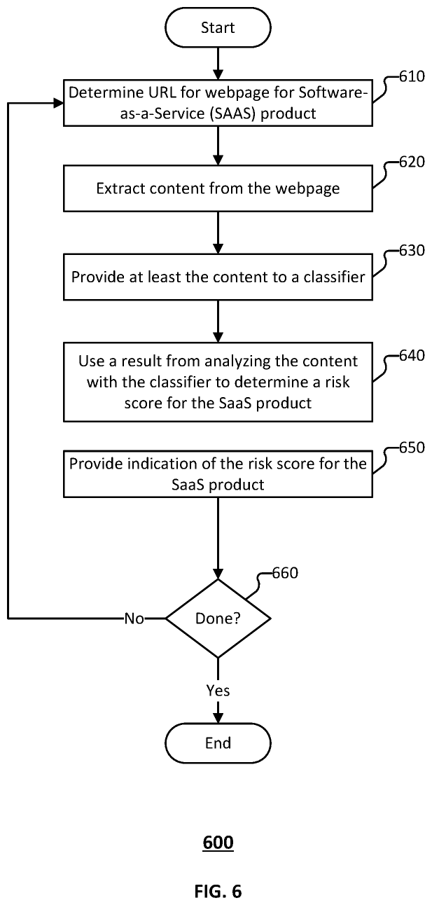

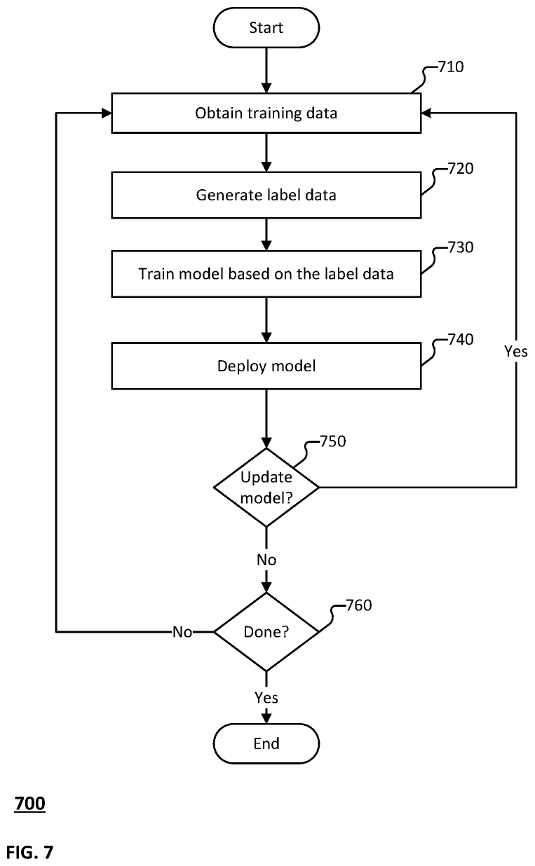

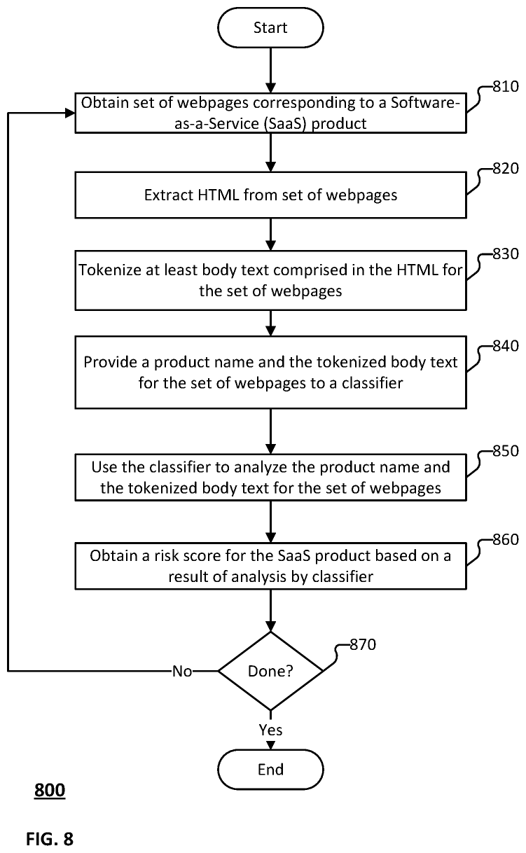

FIG. 1 is a block diagram of an environment in which a product compliance is automatically detected according to various embodiments. In some embodiments, system 100 implements process 300 of FIG. 3, process 500 of FIG. 5, process 600 of FIG. 6, process 700 of FIG. 7, and/or process 800 of FIG. 8.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy) regarding communications between client devices, such as client devices 104 and 106, and nodes outside of enterprise network 110 (e.g., reachable via external network 118), such as SaaS products. Examples of such policies include policies governing traffic shaping, quality of service, and routing of traffic. Other examples of policies include security policies such as ones requiring the scanning for threats in incoming (and/or outgoing) email attachments, web site content, inputs to application portals (e.g., web interfaces), files exchanged through instant messaging programs, and/or other file transfers. Other examples of policies include security policies that selectively block traffic, such as traffic to SaaS products that are non-compliant with respect to one or more predefined protocols or to SaaS products deemed to be risky (e.g., SaaS products having a risk score that exceeds a risk threshold). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android .apk files, iOS applications, Windows PE files, Adobe Acrobat PDF files, Microsoft Windows PE installers, web browsers, SaaS product client applications, SaaS product integrations, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with a remote security platform 140. Security platform 140 can provide a variety of services, including performing static and/or dynamic analysis on SaaS products, assessing compliance or non-compliance of SaaS products with respect to one or more protocols, determining whether a SaaS product is compliant with a particular protocol, to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a SaaS product is compliant with respect to a protocol(s) or a likelihood that a SaaS product is non-compliant with respect to a protocol(s), providing a risk score indicating an extent of risk associated with using the SaaS product (e.g., a risk of information leakage, a risk that processing/handling/storage of information is not ideal or not in conformance with regulations, etc.) providing/updating a whitelist of SaaS products (e.g., SaaS products deemed compliant or that are not deemed risky), providing/updating input strings, files, or domains deemed to be malicious, identifying malicious input strings, detecting malicious input strings, detecting malicious files, predicting whether an input strings, files, or domains is malicious, and providing an indication that an input string, file, or domain is malicious (or benign). In various embodiments, results of analysis (and additional information pertaining to applications, domains, etc.) are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remainder portions of security platform 140 provided by dedicated hardware owned by and under the control of the operator of security platform 140.

In some embodiments, system 100 (e.g., SaaS product risk assessor 170, security platform 140, etc.) trains a model to determine whether a SaaS product is compliant with one or more protocols, determine a likelihood of whether a SaaS product is compliant with the one or more protocols, or determine a risk score associated with a SaaS product (e.g., an individual risk score with respect to a particular protocol or an aggregate risk score based on a set of protocols). In some embodiments, the model is used to detect compliant or non-compliant SaaS products (or traffic to/from compliant or non-compliant SaaS products), and in response to determining whether network traffic is corresponds to a SaaS product, handling traffic with respect to whether the SaaS product is deemed compliant or non-compliant, or otherwise based on a determination of whether the SaaS product is risk (e.g., has a risk core that exceeds a risk threshold).

In some embodiments, system 100 (e.g., SaaS product risk assessor 170, security platform 140, etc.) trains a model to determine whether a SaaS product is compliant or non-compliant with a particular protocol or set of protocols or otherwise determine a risk score of the SaaS product and/or whether the SaaS product is risky. The system 100 performs a malicious feature extraction, performs an exploit feature extraction based at least in part on the HTML and/or HAR associated with the webpage for the domain and/or a set of regexes, signatures, or other patterns associated with the webpage, and generates a set of feature vectors for training a machine learning model for detecting parked domains. The system then uses the set of feature vectors to train a machine learning model 176 (e.g., a detection model) such as based on training data that includes one or more of parked domains and unparked domains (e.g., benign or otherwise legitimate domains).

In some embodiments, system 100 (e.g., SaaS product risk assessor 170, security platform 140, etc.) trains a set of models used to determine a risk associated with a SaaS product or whether the SaaS product is compliant or non-compliant with a set of protocols. For example, system 100 uses a different model for assessing the SaaS product with respect to a different protocol (e.g., system 100 stores a mapping of protocols to models).

According to various embodiments, security platform 140 comprises DNS tunneling detector 138 and/or SaaS product risk assessor 170. SaaS product risk assessor 170 is used in connection with determining a risk corresponding to a SaaS product or determining whether the SaaS product is compliant or non-compliant with respect to one or more protocols. In response to receiving an indication that an assessment of whether a SaaS product is compliant with respect to a set of one or more protocols is to be performed or that a risk associated with a SaaS product is to be assessed, SaaS product risk assessor 170 analyzes SaaS product (e.g., one or more websites for the SaaS product) and determines whether the SaaS product is compliant, a likelihood that the SaaS product is compliant/non-compliant, a risk for the SaaS product, etc. For example, SaaS product risk assessor 170 determines label data for training the model (e.g., one or more feature vectors for SaaS product), and uses model 176 to determine (e.g., predict) whether the SaaS product is compliant or non-compliant or a risk score for the SaaS product. SaaS product risk assessor 170 determines whether the SaaS product is compliant with one or more protocols based at least in part on one or more characteristics pertaining to one or more webpages for the SaaS product. In some embodiments, SaaS product risk assessor 170 receives an indication of a SaaS product (e.g., a name of the SaaS product), obtains a webpage for the SaaS product, performs a feature extraction (e.g., a feature extraction with respect to one or more characteristics for content included in the webpage, etc.), and determines (e.g., predicts) whether the SaaS product is compliant/non-compliant (or determines a risk of the SaaS product) based at least in part on the feature extraction results. For example, SaaS product risk assessor 170 uses a classifier (e.g., a detection model such as ML model 176) to determine (e.g., predict) whether the SaaS product is compliant/non-compliant, or a risk of the SaaS product based at least in part on the feature extraction results.

In some embodiments, SaaS product risk assessor 170 comprises one or more of webpage parser 172, prediction engine 174, ML model 176, and/or cache 178.

Webpage parser 172 is used in connection with determining (e.g., isolating) one or more characteristics associated with a SaaS product being analyzed. In response to determining that an assessment of compliant/non-compliance or risk of a SaaS product is to be performed, system 100 (e.g., security platform 140) obtains a webpage for the SaaS product. System 100 can obtain the webpage(s) for the SaaS product by querying a search engine and filtering the results for a relevant webpage(s). In response to determining the relevant webpage(s) (e.g., the webpage for the SaaS product), webpage parser 172 can obtain content for the webpage content and extract information or characteristics pertaining to the SaaS product/webpage from the webpage content. Examples of information that webpage parser 172 obtains based on analyzing the webpage content include (i) lengths of resource links, (ii) link text), (iii) total text, (iv) amount of text, (v) amount of HTML, (vi) patterns in the HTML, (vii) an indication of whether certain content matches predefined regexes, (viii) information pertaining to the privacy policy on the webpage, (ix) information pertaining to the contact information on the webpage.

In some embodiments, system 100 (e.g., security platform 140) obtains a webpage(s) pertaining to the SaaS product for which an assessment is to be performed, or a webpage pertaining to compliance of the SaaS product with respect to a particular protocol, based on querying a search engine. For example, the search engine can be queried using the product name (or other identifier of the SaaS product) and a name (or other identifier) for the protocol for which compliance/risk is to be assessed. The search engine can provide a set of results for the query. System 100 (e.g., security platform 140) can filter the set of results and select one or more webpages deemed relevant for assessment of compliance with respect to the protocol. In some embodiments, system 100 selects the top result returned by the search engine (e.g., according to the search engine rankings). System 100 can use the webpage corresponding to the top result if the top result corresponds to a webpage under the same domain as the SaaS product or vendor for the SaaS product. As an example, in the case of assessing whether Microsoft® Teams is compliant with a protocol, system 100 queries a search engine (e.g., Microsoft® Bing) and determines whether the top result returned by the search engine is a webpage under the domain www.microsoft.com, etc. In response to determining that the top result is a webpage under the domain for the SaaS product or vendor for the SaaS product, system 100 uses the webpage in connection with assessing the compliance/risk of the SaaS product. In some embodiments, the systems uses the most highly ranked result that matches a domain for the SaaS product or vendor thereof.

In some embodiments, in response to determining that the top result does not correspond to a webpage under the domain for the SaaS product or vendor thereof, the system uses a blank webpage in connection with querying a classifier (e.g., model 176) for a determination/prediction compliance/risk for a SaaS product with respect to the one or more protocols. A blank webpage may be used in order to reduce/eliminate the risk of the classifier providing a false indication that the SaaS product is compliant. The blank webpage may be used in connection with system 100 inferring that the SaaS product is non-compliant based on the results returned by the search engine. As an example, if the search query of product identifier+protocol identifier returns results mostly relevant/matching the protocol identifier but not the conjunction of the product identifier and protocol identifier, webpages returned by such a query may include characteristics that are similar to those product webpages for compliant products. One particular example is that the top result for the search query may be a wiki webpage pertaining to the protocol (e.g., a webpage that does not particularly pertain to the SaaS product).

In some embodiments, system 100 determines the relevant webpages (e.g., webpages to use for assessing the compliance/risk of the SaaS product) based on selecting one or more of the most highly ranked results that are under the main domain for the SaaS product or vendor thereof. For example, system 100 selects a predetermined number of most highly ranked results (e.g., the two or three most highly ranked results, etc.) under the main domain. If the system 100 uses multiple webpages (e.g., a plurality of the results returned by the query) in connection with assessing the compliance/risk of the SaaS product, webpage parser 172 gets the links (e.g., URLs) for such webpages and combines all the webpages to form a single webpage to be provided to the ML model 176.

Webpage parser 172 can extract various information from the relevant webpage(s). For example, webpage parser 172 extract HTML and/or body text from the webpage(s). In some embodiments, webpage parser 172 extracts the HTML for the webpage and then in turn extracts body text from the HTML.

In some embodiments, one or more feature vectors corresponding to the SaaS product (e.g., the webpage for the SaaS product) are determined by SaaS product risk assessor 170 (e.g., webpage parser 172 or prediction engine 174). For example, the one or more feature vectors are determined (e.g., populated) based at least in part on the one or more characteristics or attributes associated with the webpage content (e.g., information pertaining to links or text included in the content, etc.). As an example, webpage parser 172 uses the one or more attributes associated with the webpage for the SaaS product in connection with determining the one or more feature vectors. In some implementations, webpage parser 172 determines a combined feature vector based at least in part on the one or more feature vectors corresponding to the SaaS product (e.g., the webpage for the SaaS product). As an example, a set of one or more feature vectors is determined (e.g., set or defined) based at least in part on the model used to assess compliance/risk of the SaaS product. SaaS product risk assessor 170 can use the set of one or more feature vectors to determine the one or more attributes of patterns that are to be used in connection with training or implementing the model (e.g., attributes for which fields are to be populated in the feature vector, etc.). The model may be trained using a set of features that are obtained based at least in part on sample webpages for SaaS products (e.g., a set of webpages/SaaS products that are manually classified or labeled), such as a set of features corresponding to predefined regex statements and/or a set of feature vectors determined based on an algorithmic-based feature extraction. For example, the model is determined based at least in part on performing a compliance feature extraction (or a risk feature extraction) in connection with generating (e.g., training) a model to detect a risk for the SaaS product or whether the SaaS product is compliant/non-compliant with a protocol. The compliance feature extraction (or a risk feature extraction) can include one or more of (i) using predefined regex statements to obtain specific features from webpage content for SaaS products, and (ii) using an algorithmic-based feature extraction to filter out described features from a set of raw input data. In some embodiments, the predefined regex statements are determined based on analyzing a set of sample webpages for compliant SaaS products or a set of sample webpages for non-compliant SaaS products, and determining patterns corresponding to compliant SaaS products, patterns corresponding to non-compliant SaaS products, patterns for risky SaaS products, etc.

In response to receiving an indication of a SaaS product for which SaaS product risk assessor 170 is to determine whether the SaaS product is compliant with one or more protocols (or a likelihood that the SaaS product is compliant), SaaS product risk assessor 170 determines the one or more feature vectors (e.g., individual feature vectors corresponding to a set of predefined regex statements, individual feature vectors corresponding to attributes or patterns obtained using an algorithmic-based analysis of indications of compliance/non-compliance or risk, and/or a combined feature vector of both, etc.). As an example, in response to determining (e.g., obtaining) the one or more feature vectors, SaaS product risk assessor 170 (e.g., webpage parser 172) provides (or makes accessible) the one or more feature vectors to prediction engine 174 (e.g., in connection with obtaining a prediction of whether the SaaS product is compliant). As another example, SaaS product risk assessor 170 (e.g., webpage parser 172) stores the one or more feature vectors such as in cache 178 or database 160.

In some embodiments, prediction engine 174 determines whether the SaaS product is compliant with a protocol, or a likelihood that the SaaS product is compliant, based at least in part on one or more of (i) a mapping of SaaS products (or identifiers thereof) to indications of whether the corresponding SaaS products are compliant with one or more protocols, and/or (iii) a classifier (e.g., a model trained using a machine learning process, etc.), such as ML model 176.

According to various embodiments, prediction engine 174 determines whether a SaaS product is compliant/non-compliant with one or more protocols or whether the SaaS product is risky (e.g., has a risk score that exceeds a risk threshold) based at least in part on webpage content for the SaaS product, such as one or more characteristics of the webpage (e.g., regex statements, information pertaining to links, information pertaining to text, etc.). For example, prediction engine 174 applies a machine learning model to determine whether the SaaS product is compliant with a particular one or more protocols. Applying the machine learning model to determine whether the SaaS product is compliant/non-compliant or risky may include prediction engine 174 querying machine learning model 176 (e.g., with information pertaining to the webpage for the SaaS product, one or more feature vectors, etc.). In some implementations, machine learning model 176 is pre-trained and prediction engine 174 does not need to provide a set of training data (e.g., sample webpages for compliant SaaS products and/or sample webpages for non-compliant SaaS products) to machine learning model 176 contemporaneous with a query for an indication/determination of whether a particular SaaS product is compliant or non-compliant (or otherwise deemed a risky SaaS product). In some embodiments, prediction engine 174 receives information associated with whether the particular SaaS product is compliant (e.g., an indication that the particular SaaS product is compliant to a particular protocol(s)). For example, prediction engine 174 receives a result of a determination or analysis by machine learning model 176. In some embodiments, prediction engine 174 receives, from machine learning model 176, an indication of a likelihood that particular SaaS product is compliant. In response to receiving the indication of the likelihood that the particular SaaS product is compliant, prediction engine 174 determines (e.g., predicts) whether the particular SaaS product is compliant domain based at least in part on the likelihood that the particular SaaS product is compliant. For example, prediction engine 174 compares the likelihood that the particular SaaS product is compliant to a likelihood threshold value. In response to a determination that the likelihood that the particular SaaS product is compliant is greater than a likelihood threshold value, prediction engine 174 may deem (e.g., determine that) the particular SaaS product to be compliant with the particular protocol(s). In response to a determination that the likelihood that the particular SaaS product is compliant is less than (or less than or equal to) a likelihood threshold value, prediction engine 174 may deem (e.g., determine that) the particular SaaS product to be non-compliant with the particular protocol(s).

In some embodiments, prediction engine 174 determines a risk score for the SaaS product based at least in part on the indication (or likelihood) of whether the SaaS product is compliant with a particular protocol. The risk score may be indicative of an extent of the enterprise risk associated with use of the SaaS product (e.g., a risk of information leakage, a risk of non-compliance with a law or regulation, etc.). The risk score can be computed based on a predefined risk score algorithm. An aggregated risk score may be computed that uses indications of whether the SaaS product is compliant/non-compliant with a plurality of protocols. The various protocols within the plurality of protocols may have different corresponding weightings used to compute the aggregated risk score. In some embodiments, the aggregated risk score is an average score among the risk scores for the SaaS product with respect to different protocols. In some embodiments, system 100 further determines an enterprise risk score for a set of SaaS products based at least in part on aggregated risk scores corresponding to the SaaS products within the set of SaaS products.

According to various embodiments, in response to prediction engine 174 determining that the SaaS product is compliant, system 100 sends to a security entity an indication that the SaaS product is compliant. For example, SaaS product risk assessor 170 may send to a security entity (e.g., a firewall) or network node (e.g., a client) an indication that the SaaS product is compliant, or alternatively, send an indication that the SaaS product is non-compliant in the case that prediction engine 174 determines that the SaaS product is non-compliant. The indication that the SaaS product is non-compliant may correspond to an update to a blacklist of SaaS products (e.g., corresponding to non-compliant products with respect to one or more protocols), or an update to a whitelist of SaaS products (e.g., corresponding to compliant SaaS products).

Prediction engine 174 is used in connection with determining whether the SaaS product is compliant with one or more protocols (e.g., determining a likelihood or prediction of whether the SaaS product is compliant), or a risk score indicating an extent of risk to an enterprise by use of the SaaS product. Prediction engine 174 uses information pertaining to the webpage for the SaaS product (e.g., one or more characteristics, patterns, links, text, etc.) in connection with determining whether the corresponding SaaS product is compliant.

Prediction engine 174 is used to determine whether the SaaS product is compliant with one or more protocols. In some embodiments, prediction engine 174 determines a set of one or more feature vectors based at least in part on information pertaining to the webpage for the SaaS product. For example, prediction engine 174 determines feature vectors for (e.g., characterizing) one or more of (i) a set of regex statements (e.g., predefined regex statements), (ii) a set of signatures or patterns of webpages, and/or (ii) one or more characteristics or relationships determined based on an algorithmic-based feature extraction. The feature vectors can be based at least in part on body text extracted from the webpage for the SaaS product. In some embodiments, prediction engine 174 uses a combined feature vector in connection with determining whether a SaaS product is compliant with one or more feature vectors. The combined feature vector is determined based at least in part on the set of one or more feature vectors. In some embodiments, prediction engine 174 determines the combined feature vector by concatenating the set of feature vectors for the predefined set of regex statements and/or the set of feature vectors for the characteristics or relationships determined based on an algorithmic-based feature extraction. Prediction engine 174 concatenates the set of feature vectors according to a predefined process (e.g., predefined order, etc.).

In response to determining the set of feature vectors or the combined feature vector, prediction engine 174 uses a classifier to determine whether the SaaS product is compliant with one or more protocols. The classifier is used to determine whether the SaaS product is compliant based at least in part on the set of feature vectors or the combined feature vector. In some embodiments, the classifier is a machine learning classifier, such as a classifier that is trained using a machine learning process. The classifier may be a Convolutional Neural Network (CNN) model. Prediction engine 174 uses a result of analyzing the set of feature vectors or combined feature vector(s) with the classifier to determine whether the SaaS product is compliant with a particular protocol(s). In some embodiments, the classifier corresponds to machine learning model 176.

According to various embodiments, prediction engine 174 uses the set of feature vectors obtained based on a dynamic analysis of the sample to determine whether the domain is a parked domain. In some embodiments, if a result of analyzing the feature vector(s) (e.g., the combined feature vector) using the classifier is less than a predefined threshold (e.g., a predefined compliance threshold, etc., or alternatively greater than a predefined risk threshold, etc.), system 100 deems (e.g., determines) that the SaaS product is not compliant (e.g., the SaaS product is risky). For example, if the result from analyzing the feature vector(s) indicates a likelihood of whether the SaaS product is compliant, then the predefined threshold can correspond to a threshold likelihood. As another example, if the result from analyzing the feature vector(s) indicates a degree of similarity of the webpage for the SaaS product to a webpage for a non-compliant SaaS product, then the predefined threshold can correspond to a threshold likelihood. In some embodiments, if a result of analyzing the feature vector(s) (e.g., the combined feature vector) using the classifier is greater than (or greater than or equal to) a predefined threshold (e.g., the predefined compliance threshold), system 100 deems (e.g., determines) that the SaaS product is compliant.

In some embodiments, system 100 (e.g., security platform 140) monitors traffic across a network or applications used at client systems. Based on the monitoring the traffic, system 100 determines one or more applications (e.g., SaaS products) used in an environment (e.g., used via an enterprise network or among client systems managed by the enterprise, etc.). System 100 (e.g., security platform) determines whether the one or more applications are trusted applications (e.g., SaaS products that are compliant with a particular set of protocols, or SaaS products having a risk score that is greater than a predefined risk threshold). System 100 can provide to an enterprise (e.g., client systems or a network leveraging security platform 140) an indication of a risk for each application being used among the client systems or across the network, or an indication of a total risk score for the set of application used among the client systems or across the network.

System 100 (e.g., security platform) can use different predefined risk thresholds or predefined compliance thresholds for each SaaS product associated with each compliance protocol. The risk thresholds or compliance thresholds can be configurable, such as based on a false positive rate (e.g., to adjust the sensitivity or false positive rates). As an example, the risk thresholds or compliance thresholds can be set to obtain a false positive rate of 10%. Similarly, system 100 can use different models for each protocol (or different models for different sets of protocols) for which compliance of SaaS products is to be assessed.

In some embodiments, system 100 uses machine learning model to determine an extent of one or more other security attributes, one or more product attributes or product features, etc. Examples of other security attributes can include an indication that the application is a SaaS application or not a SaaS application, a type of authentication used by the application, etc. System 100 can search for webpages for the application, extract characteristics (e.g., body text) from the application, and use a machine learning model to predict/determine the security attribute(s) or product attribute(s)/feature(s).

In response to receiving an indication that a particular SaaS product is to be assessed, SaaS product risk assessor 170 can determine whether the SaaS product corresponds to a previously SaaS product (e.g., a previous determination of whether the SaaS product is compliant or non-compliant, a risk associated with the SaaS product, etc.). As an example, SaaS product risk assessor 170 determines whether an identifier or representative information corresponding to the SaaS product is comprised in the historical information (e.g., a blacklist, a whitelist, etc.). In some embodiments, representative information corresponding to the SaaS product is a hash or signature of the webpage for the SaaS product. In some embodiments, SaaS product risk assessor 170 (e.g., prediction engine 174) determines whether information pertaining to a particular SaaS product is comprised in a dataset of historical domains (e.g., historical parked domains) and historical information associated with the historical dataset indicating whether a SaaS product is compliant with one or more protocols (e.g., historical information received a third-party service such as VirusTotal™, or historical information based on previous manual classifications/labeling of the corresponding SaaS products). In response to determining that information pertaining to a particular SaaS product is not comprised in, or available in, the dataset of historical SaaS products/product assessments, SaaS product risk assessor 170 may deem that the SaaS product has not yet been analyzed and SaaS product risk assessor 170 can invoke an analysis (e.g., a dynamic analysis) of the SaaS product (e.g., the webpage for the SaaS product) in connection with determining (e.g., predicting) whether the SaaS product is compliant with one or more particular protocols (e.g., SaaS product risk assessor 170 can query a classifier based on the SaaS product, or information from a webpage for the SaaS product, in connection with determining whether the SaaS product is compliant). An example of the historical information associated with the historical domains indicating whether a SaaS product corresponds to a VirusTotal® (VT) score. In the case of a VT score greater than 0 for a SaaS product, the SaaS product is deemed to be a non-compliant SaaS product or a risky SaaS product by the third-party service. In some embodiments, the historical information associated with the historical the SaaS products indicating whether a particular SaaS product is compliant with one or more particular protocols, or whether the SaaS product is risky, corresponds to a social score such as a community-based score or rating (e.g., a reputation score) indicating that a SaaS product is non-compliant or likely to be risky/non-compliant. The historical information (e.g., from a third-party service, a community-based score, previous manual labeling, etc.) indicates whether other vendors or cyber security organizations deem the particular domain is a parked domain and/or otherwise malicious.

In some embodiments, SaaS product risk assessor 170 (e.g., prediction engine 174) determines that a SaaS product is newly analyzed (e.g., that the SaaS product is not within the historical information/dataset, is not on a whitelist or blacklist, etc.). SaaS product risk assessor 170 (e.g., webpage parser 172) may detect that a domain is newly analyzed in response to security platform 140 receiving an indication of the SaaS product (e.g., a request for assessment of a SaaS product) from a security entity (e.g., a firewall) or endpoint within a network. For example, SaaS product risk assessor 170 determines that a SaaS product is newly analyzed contemporaneously with receipt of the indication of the SaaS product by security platform 140 or SaaS product risk assessor 170. In response to determining that a SaaS product that is received that has not yet been analyzed with respect to whether such SaaS product is compliant with one or more particular protocols (e.g., the system does not comprise historical information with respect to such SaaS product), SaaS product risk assessor 170 determines whether to use an analysis (e.g., dynamic analysis) of the SaaS product (e.g., to query a classifier to analyze the SaaS product or one or more characteristics associated with the webpage for the SaaS product, etc.) in connection with determining whether the SaaS product is compliant, and SaaS product risk assessor 170 uses a classifier with respect to a set of feature vectors or a combined feature vector associated with characteristics or relationships of attributes or characteristics in the webpage for the SaaS product.

Machine learning model 176 predicts whether a SaaS product is compliant with one or more protocols, or is deemed a risky product, based at least in part on a model. As an example, the model is pre-stored and/or pre-trained. The model can be trained using various machine learning processes. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. According to various embodiments, machine learning model 176 uses a relationship and/or pattern of attributes, characteristics, relationships among attributes or characteristics of webpage content for the SaaS product and/or a training set to estimate whether the SaaS product, such as to predict a likelihood that the SaaS product is compliant with one or more protocols. For example, machine learning model 176 uses a machine learning process to analyze a set of relationships between an indication of whether a SaaS product is compliant or risky and one or more attributes pertaining to the SaaS product and uses the set of relationships to generate a prediction model for predicting whether a particular SaaS product is compliant with one or more protocols or whether the SaaS product is deemed risky. In some embodiments, in response to predicting that a particular SaaS product is non-compliant, an association between the SaaS product and the indication that the SaaS product is non-compliant is stored such as at SaaS product risk assessor 170 (e.g., cache 178). In some embodiments, in response to predicting a likelihood that a particular SaaS product is a non-compliant (or alternatively, compliant), an association between the SaaS product and the likelihood that the SaaS product non-compliant is stored such as at SaaS product risk assessor 170 (e.g., cache 178). Machine learning model 176 may provide the indication of whether a SaaS product is compliant, or a likelihood that the SaaS product is compliant, to prediction engine 174. In some implementations, machine learning model 176 provides prediction engine 174 with an indication that the analysis by machine learning model 176 is complete and that the corresponding result (e.g., the prediction result) is stored in cache 178.

According to various embodiments, machine learning model 176 uses one or more features in connection with predicting whether a SaaS product is compliant (or a likelihood that SaaS product is compliant, or whether the SaaS product is deemed risky). For example, machine learning model 176 may be trained using one or more features. The features may be determined based at least in part on one or more characteristics or attributes pertaining to webpages for SaaS products. Examples of the features used in connection with training/applying the machine learning model 176 include (a) a set of features respectively corresponding to a set of predefined regex statements or a set of regex statements determined by extraction from a training set, (b) a set of features obtained based on an algorithmic-based feature extraction; etc. As an example, the set of features based on an algorithmic-based feature extraction may include a set of signature count features. Various other features may be implemented in connection with training and/or applying the model. In some embodiments, a set of features are used to train and/or apply the model. Weightings may be used to weight the respective features in the set of features used to train and/or apply the model. The weightings may be determined based at least in part on the generating (e.g., determining) the model.

Cache 178 stores information pertaining to a SaaS product. In some embodiments, cache 178 stores mappings of indications of whether a SaaS product is compliant (or likely compliant) to particular protocol(s), etc. Cache 178 may store additional information pertaining to a set of SaaS products such as attributes of the webpages for the SaaS products, hashes or signatures corresponding to a webpage for a SaaS product in the set of SaaS products, other unique identifiers corresponding to the SaaS product, etc.

Returning to FIG. 1, suppose that a malicious individual (using client device 120) has created malware or malicious input string 130. The malicious individual hopes that a client device, such as client device 104, will execute a copy of malware or other exploit (e.g., malware or malicious input string) 130, compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as command and control (C&C) server 150, as well as to receive instructions from C&C server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C&C server 150. Enterprise DNS server 122 is configured to resolve enterprise domain names into IP addresses and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C&C server 150, client device 104 will need to resolve the domain, “kj32hkjqfeuo32y1hkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C&C server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, permitting traffic to/from certain domains, and/or other file transfers, and/or quarantining or deleting files or other exploits identified as being malicious (or likely malicious). In some embodiments, data appliance 102 is also configured to enforce policies with respect to traffic that stays within enterprise network 110.

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. This query can be performed contemporaneously with receipt of the file or input string, or in response to a request from a user to scan the file. As one example, data appliance 102 can send a query (e.g., in the JSON format) to a frontend 142 of security platform 140 via a REST API.

In some embodiments, SaaS product risk assessor 170 provides to a security entity, such as data appliance 102, an indication whether a SaaS product is compliant with one or more particular protocols. For example, in response to determining that the SaaS product is compliant with one or more protocols, SaaS product risk assessor 170 sends an indication that the SaaS product is compliant to data appliance 102, and the data appliance 102 may in turn enforce one or more security policies based at least in part on the indication that the SaaS product is compliant or an indication that the SaaS product is non-compliant. The one or more security policies may include isolating/quarantining the webpage content or traffic for the domain(s) corresponding to the SaaS product, blocking access to the domain(s) corresponding to the SaaS product, isolating/deleting the access requests for the domain(s) corresponding to the SaaS product, ensuring that the domain(s) corresponding to the SaaS product is not resolved, alerting or prompting the user of the client device that the SaaS product is non-compliant or otherwise deemed risky prior to the user obtaining access to the SaaS products, alerting or prompting an administrator of an enterprise network that the SaaS product is non-compliant or is otherwise deemed risky, or that the enterprise risk exceeds a risk threshold, etc. As another example, in response to determining that the SaaS product is compliant, SaaS product risk assessor 170 provides to the security entity an update of a mapping of SaaS products (or hashes, signatures, or other unique identifiers corresponding to webpages for the SaaS product) to indications of whether a corresponding SaaS product is compliant with one or more protocols, or an update to a blacklist for SaaS products (e.g., for non-compliant SaaS products) or a whitelist for compliant SaaS products (e.g., identifying SaaS products that are not deemed risky).

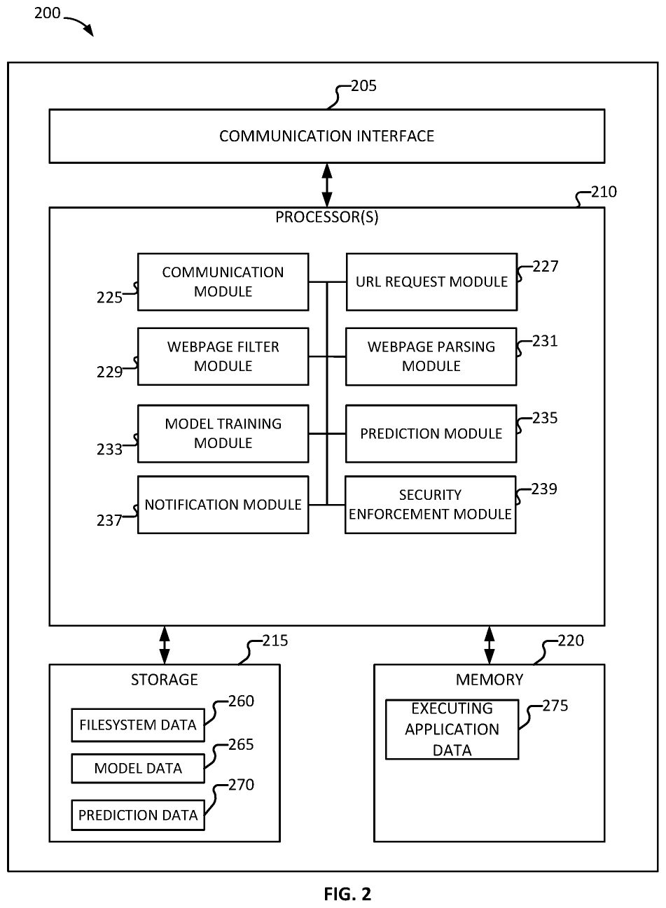

FIG. 2 is a block diagram of a system for detecting whether a product is compliant with one or more protocols according to various embodiments. According to various embodiments, system 200 is implemented in connection with system 100 of FIG. 1, such as for SaaS product risk assessor 170. In various embodiments, system 200 is implemented in connection with process 300 of FIG. 3, process 500 of FIG. 5, process 600 of FIG. 6, process 700 of FIG. 7, and/or process 800 of FIG. 8. System 200 may be implemented in one or more servers, a security entity such as a firewall, and/or an endpoint.

System 200 can be implemented by one or more devices such as servers. System 200 can be implemented at various locations on a network. In some embodiments, system 200 implements SaaS product risk assessor 170 of system 100 of FIG. 1. As an example, system 200 is deployed as a service, such as a web service (e.g., system 200 determines whether an input string or received file is malicious and provides such determinations as a service). The service may be provided by one or more servers. For example, system 200 or the parked domain detector is deployed on a remote server that monitors or receives domains (or domain access requests) that are transmitted within or into/out of a network and determines whether the domain is a parked domain and sends/pushes out notifications or updates pertaining to the domain such as an indication whether a domain is a parked domain. As another example, the malicious sample detector is deployed on a firewall. In some embodiments, part of system 200 is implemented as a service (e.g., a cloud service provided by one or more remote servers) and another part of system 200 is implemented at a security entity or other network node such as a client device.

According to various embodiments, in response to receiving the domain (e.g., a domain access request) to be analyzed to determine whether the sample is malicious, system 200 uses a classifier to determine whether the SaaS product is compliant with one or more particular protocols (or to determine a likelihood that the SaaS product is compliant with one or more particular protocols), or to determine a risk (or extent of a risk) for the SaaS product. For example, system 200 uses the classifier to provide a prediction of whether the SaaS product is compliant with a particular protocol(s). The prediction can include an indication of a likelihood that the SaaS product is compliant. System 200 determines one or more feature vectors corresponding to the SaaS product (or webpage for the SaaS product) and uses the classifier to analyze the one or more feature vectors in connection with determining whether the SaaS product is compliant with a protocol(s), deemed risky, etc.

In some embodiments, system 200 (i) receives an indication of a SaaS product (e.g., a domain access request, a product name for the SaaS product, etc.), (ii) obtains a webpage for the SaaS product, (iii) performs a feature extraction, and (iv) uses a classifier to determine whether the SaaS product is compliant with a corresponding protocol (or set of protocols) or likely to be in compliance based at least in part on the feature extraction results. System 200 can perform an active measure (or cause an active measure to be performed) in response to determining that a SaaS product is not compliant with a protocol(s) or that the SaaS product is deemed risky.

In the example shown, system 200 implements one or more modules in connection with predicting whether a SaaS product is compliant with a protocol(s), determining a likelihood that the SaaS product is compliant with a protocol(s), determining whether a SaaS product is deemed risky, and/or providing a notice or indication of whether a SaaS product is compliant with a particular protocol. System 200 comprises communication interface 205, one or more processors 210, storage 215, and/or memory 220. One or more processors 210 comprises one or more of communication module 225, URL request module 227, webpage filter module 229, webpage parsing module 231, model training module 233, prediction module 235, notification module 237, and security enforcement module 239.

In some embodiments, system 200 comprises communication module 225. System 200 uses communication module 225 to communicate with various nodes or end points (e.g., client terminals, firewalls, DNS resolvers, data appliances, other security entities, etc.) or user systems such as an administrator system. For example, communication module 225 provides to communication interface 205 information that is to be communicated (e.g., to another node, security entity, etc.). As another example, communication interface 205 provides to communication module 225 information received by system 200. Communication module 225 is configured to receive an indication of SaaS products to be analyzed (or domain access requests indicating a SaaS product) or indications of one or more protocols for which compliance of a SaaS product is to be assessed, such as from network endpoints or nodes such as security entities (e.g., firewalls), database systems, query systems, etc. Communication module 225 is configured to obtain a webpage (e.g., webpage content) for a SaaS product to be analyzed. Communication module 225 is configured to query third party service(s) for information pertaining to domains (e.g., services that expose information for domains such as third-party scores or assessments of maliciousness of domains or indications of whether domains are parked domains, a community-based score, assessment, or reputation pertaining to domains, a blacklist for domains, and/or a whitelist for domains, etc.). System 200 can use communication module 225 to query a search engine for results pertaining to a query (e.g., a query pertaining to the SaaS product and/or protocol being analyzed). Communication module 225 is configured to receive one or more settings or configurations from an administrator. Examples of the one or more settings or configurations include configurations of a process determining the SaaS product is compliant with a protocol, a format or process according to which a combined feature vector is to be determined, a set of feature vectors to be provided to a classifier for determining whether the SaaS product is compliant, a set of regex statements for which feature vectors are to be determined (e.g., a set of predefined regex statements, or an update to a stored set of regex statements, etc.), a set of predefined signatures to be assessed or counted, information pertaining to a whitelist of SaaS products, information pertaining to a blacklist of SaaS products (e.g., SaaS products that are deemed to be non-compliant or risky), one or more thresholds such as a risk threshold(s), a compliance threshold(s), etc.

In some embodiments, system 200 comprises URL request module 227. System 200 uses the URL request module 227 to obtain a webpage for the SaaS product (e.g., a website for which information is to be assessed to determine whether the SaaS product is compliant with a protocol), etc. In response to obtaining an indication that a SaaS product is to be assessed for compliance with one or more protocols, system 200 uses URL request module 227 to query a search engine for webpages pertaining to the SaaS product. The indication that the SaaS product is to be analyzed can be obtained from a client terminal or security entity, such as in response to monitoring traffic for the terminal or network. In response to detecting a domain access request, etc., the client terminal or security entity may query system 200 (e.g., URL request module 227) for a determination of whether the SaaS product is compliant or risky. URL request module 227 can be configured to query a search engine (or a plurality of search engines) for a set of results for webpages that may relate to the SaaS product and/or the protocol(s) for which the compliance of the SaaS product is to be assessed. As an example, URL request module 227 queries the Microsoft® Bing search engine for a set of results. In some embodiments, URL request module 227 queries the search engine using a product URL, such as a URL for a webpage for the product (e.g., a webpage hosted on a domain of the vendor of the SaaS product). URL request module 227 receives, via communication module 225, a set of results returned by the search engine in response to the query.

In some embodiments, system 200 comprises webpage filter module 229. System 200 uses webpage filter module 229 to filter the set of results returned by the search engine. In some embodiments, system 200 uses webpage filter module 229 to determine (e.g., extract from the set of results) one or more webpages that are deemed to be relevant to the SaaS product compliance with one or more protocols. As an example, webpage filter module 229 can be configured to deem the top result (e.g., the highest-ranking result) to be the relevant webpage for the SaaS product if the domain for the top result matches a domain associated with the SaaS product (e.g., a domain for the vendor of the SaaS product). As an example, webpage filter module 229 can be configured to deem the top result having a domain matching the domain associated with the SaaS product among the set of results (e.g., the highest-ranking result for which the domain matches the SaaS product). As another example, webpage filter module 229 determines a subset of the set of results pertaining to the SaaS product and/or the protocol(s), such as a set of webpages having domains matching the domain for the SaaS product. In response to determining that the top result does not correspond to a webpage under the domain for the SaaS product or vendor thereof, webpage filter module generates a blank webpage for use in connection with querying a classifier (e.g., a model) for a determination/prediction compliance/risk for a SaaS product with respect to the one or more protocols.

In some embodiments, system 200 comprises webpage parsing module 231. System 200 uses the webpage parsing module 231 to obtain webpage content (e.g., body text) for the SaaS product and to parse the webpage content to obtain information pertaining to the SaaS product. For example, webpage parsing module 231 determines one or more characteristics pertaining to the SaaS product. Examples of the one or more characteristics obtained by webpage parsing module 231 include information pertaining to links in the webpage content (e.g., an indication of whether a particular link is an external link or an internal link, a number of links, a length of a link, an amount of link text), information pertaining to text included in the webpage content, a ratio of a link text to total text, patterns or signatures included in the webpage content, an indication of whether the webpage content includes particular signatures or patterns such as key phrases or sections on the webpage, information pertaining to advertisements, etc.

According to various embodiments, in response to obtaining the one or more relevant webpages for the SaaS product, webpage parsing module 231 extracts body text from the webpage(s), and tokenizes and embeds the text using byte pair encoding.

In some embodiments, system 200 comprises model training module 233. System 200 uses model training module 233 to train a machine learning model. Model training module 233 can obtain a set of training data, including a set of historical information pertaining to SaaS products classified as compliant with one or more particular protocols and/or a set of historical SaaS products classified as non-compliant with one or more particular protocols. In response to obtaining the set of training data, model training module 233 determines one or more features for a model that determines whether a SaaS product is compliant/non-compliant with one or more protocols, or whether a SaaS product is deemed a risky product (e.g., a product for which a risk score exceeds a predefined risk threshold).

In response to obtaining the set of training data, system 200 uses model training module 233 to perform a feature extraction (e.g., parked domain feature extraction). The parked domain feature extraction can include one or more of (i) using predefined regex statements, signatures, or patterns, and (ii) using an algorithmic-based feature extraction to filter out described features from a set of raw input data (e.g., webpage content for domains in the set of training data). The information extracted from the training set (e.g., the historical information) can be input to a deep neural network, which can provide a prediction/verdict of whether the SaaS product is compliant/non-compliant (based on the SaaS product webpage(s)). Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, model training module 233 trains a CNN classifier model. Inputs to the classifier (e.g., the CNN classifier model) are a combined feature vector or set of feature vectors and based on the combined feature vector or set of feature vectors, the classifier model determines whether the corresponding SaaS product is compliant with one or more corresponding protocols, or a likelihood that the SaaS product is compliant. According to various embodiments, the model is trained using a convolutional neural network.

In response to obtaining an indication that a particular SaaS product is to be analyzed for compliance with respect to one or more protocols, system 200 (e.g., prediction module 235) may determine whether the SaaS product corresponds to a previously analyzed SaaS product (e.g., whether the SaaS product matches a SaaS product associated with historical information for which a determination of whether the SaaS product is a compliant or for which a risk score has been computed). As an example, system 200 (e.g., prediction module 235) queries a database or mapping of previously analyzed SaaS products and/or historical information such as blacklists of SaaS products, and/or whitelists of SaaS products in connection with determining whether the SaaS product was previously analyzed. In some embodiments, in response to determining that the domain does not correspond to a previously analyzed SaaS product, system 200 uses a classifier (e.g., a model such as a model trained using a machine learning process) to determine (e.g., predict) whether the SaaS product is compliant. In some embodiments, in response to determining that the SaaS product corresponds to a previously analyzed SaaS product, system 200 (e.g., and/or prediction module 235) obtains an indication of whether the corresponding previously analyzed SaaS product is compliant or non-compliant. System 200 can use the indication of whether the corresponding previously analyzed SaaS product is compliant as an indication of whether the received SaaS product is compliant.

In some embodiments, system 200 comprises prediction module 235. System 200 uses prediction module 235 to determine one or more feature vectors for (e.g., corresponding to) the SaaS product (e.g., one or more relevant webpages for the SaaS product). For example, system 200 uses prediction module 235 to determine a set of feature vectors or a combined feature vector to use in connection with determining whether a SaaS product is compliant with one or more protocols (e.g., using a detection model). In some embodiments, prediction module 235 determines a set of one or more feature vectors based at least in part on information pertaining to the SaaS product, such as one or more characteristics determined based at least in part on the webpage content for the SaaS product.

In some embodiments, system 200 uses prediction module 235 to determine (e.g., predict) whether a SaaS product is compliant with one or more particular protocols or likelihood that the SaaS product is compliant. Prediction module 235 uses a model (e.g., the detection model) such as a machine learning model trained by model training module 233 in connection with determining if the SaaS product is compliant with one or more particular protocols or likelihood that the SaaS product is compliant. For example, prediction module 235 uses the CNN classifier model (e.g., the detection model) to analyze the combined feature vector to determine whether the SaaS product is compliant.

In some embodiments, system 200 comprises notification module 237. System 200 uses notification module 237 to provide an indication of whether the SaaS product is compliant with one or more particular protocols (e.g., to provide an indication that the SaaS product is compliant) or whether the SaaS product is deemed risky. For example, notification module 237 obtains an indication of whether the domain is a parked domain (or a likelihood that the domain is a parked domain) from prediction module 235 and provides the indication of whether the domain is a parked domain to one or more security entities and/or one or more endpoints. As another example, notification module 237 provides to one or more security entities (e.g., a firewall), nodes, or endpoints (e.g., a client terminal) an update to a whitelist of SaaS products and/or a blacklist of SaaS products. According to various embodiments, notification module 237 obtains a hash, signature, or other unique identifier associated with the SaaS product (e.g., a webpage for the SaaS product, a hash of the domain for the webpage associated with the SaaS product, etc.), and provides the indication of whether the sample is malicious in connection with the hash, signature, or other unique identifier associated with the sample.

According to various embodiments, the hash of associated with the SaaS Product corresponds to a hash of the domain name, the IP address, or website content for the webpage for the SaaS product, etc. using a predetermined hashing function (e.g., an MD5 hashing function, etc.). A security entity or an endpoint may compute a hash of a domain for a SaaS product (e.g., based on traffic monitored by the security entity, etc.). The security entity or an endpoint may determine whether the computed hash corresponding to the SaaS product is comprised within a set such as a whitelist of benign SaaS products (e.g., trusted SaaS products, or SaaS products that are not deemed risky), and/or a blacklist of SaaS products (e.g., untrusted SaaS products, or SaaS products that are deemed risky), etc. If a signature for a SaaS product (e.g., a SaaS product corresponding to network traffic, or otherwise being used by a user on an enterprise network or set of managed devices) is included in the set of signatures for a non-compliant SaaS product (e.g., a SaaS product included in the blacklist of SaaS products), the security entity or an endpoint can prevent the transmission of content for the SaaS product (or domain for the SaaS product), or otherwise prevent access to the SaaS product.

In some embodiments, system 200 comprises security enforcement module 239. System 200 uses security enforcement module 239 to enforce one or more security policies with respect to information such as network traffic, domain access requests, input strings, files, etc. Security enforcement module 239 enforces the one or more security policies based on whether the SaaS product is determined to be compliant/non-compliant. As an example, in the case of system 200 being a security entity or firewall, system 200 comprises security enforcement module 239. Firewalls typically deny or permit network transmissions based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies. Other examples of policies include security policies such as ones requiring the scanning for threats in incoming (and/or outgoing) email attachments, website content, files exchanged through instant messaging programs, information obtained via a web interface or other user interface such as an interface to a database system (e.g., an SQL interface), and/or other file transfers.

According to various embodiments, storage 215 comprises one or more of filesystem data 260, model data 265, and/or prediction data 270. Storage 215 comprises a shared storage (e.g., a network storage system) and/or database data, and/or user activity data.

In some embodiments, filesystem data 260 comprises a database such as one or more datasets (e.g., one or more datasets for SaaS products, such as compliant SaaS products or non-compliant SaaS products, mappings of indicators of SaaS products to domains or hashes, signatures or other unique identifiers of SaaS products, mappings of indicators of compliant SaaS products to domains or hashes, signatures or other unique identifiers of SaaS products, etc.). Filesystem data 260 comprises data such as historical information pertaining to SaaS products (e.g., indications of whether SaaS products are compliant SaaS products), a whitelist of SaaS products deemed to be trusted or compliant with one or more protocols, a blacklist of SaaS products deemed to be risky or non-compliant with respect to one or more protocols, information associated with suspicious/risky or non-compliant SaaS products, etc.

Model data 265 comprises information pertaining to one or more models used to determine whether a SaaS product is compliant with one or more particular protocols, or a likelihood that a SaaS product is compliant with one or more particular protocols. As an example, model data 265 stores the classifier (e.g., a CNN model, the XGBoost machine learning classifier model(s) such as a detection model) used in connection with a set of feature vectors or a combined feature vector. Model data 265 comprises a feature vector that may be generated with respect to each of the one or more features corresponding to the model. In some embodiments, model data 265 comprises a combined feature vector that is generated based at least in part on the one or more feature vectors corresponding to the model.

Prediction data 270 comprises information pertaining to a determination of whether the SaaS products analyzed by system 200 is compliant with one or more protocols. For example, prediction data 270 stores an indication that the SaaS product is compliant with one or more protocols, an indication that the SaaS product is non-compliant with one or more protocols, etc. The information pertaining to a determination can be obtained by notification module 237 and provided (e.g., communicated to the applicable security entity, endpoint, or other system). In some embodiments, prediction data 270 comprises hashes or signatures for SaaS products such as SaaS products that are analyzed by system 200 to determine whether such SaaS products are compliant with respect to one or more protocols, or a historical dataset that has been previously assessed to determine whether the SaaS products are parked domains, such as historical determinations provided by a third party. Prediction data 270 can include a mapping of hash values or other identifiers associated with SaaS products to indications of whether the SaaS products is compliant with respect to one or more protocols (e.g., an indication that the corresponding SaaS product is compliant with one or more protocols, or non-compliant with one or more protocols, etc.).

According to various embodiments, memory 220 comprises executing application data 275. Executing application data 275 comprises data obtained or used in connection with executing an application such as an application executing a hashing function, an application to extract information from webpage content, an input string, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious input strings, suspicious files, or suspicious or unparked domains, a document preparation application, a report preparation application, a user interface application, a data analysis application, an anomaly detection application, a user authentication application, a security policy management/update application, etc.).

FIG. 3 is a block diagram of a process for detecting whether a product is compliant with one or more protocols according to various embodiments. In some embodiments, process 300 is at least partly implemented by system 100 of FIG. 1 or system 200 of FIG. 2.

At 305, a product URL is obtained. The product URL corresponds to a webpage for a SaaS product for which compliance is to be assessed or a domain for traffic to/from the SaaS product. The product URL can be obtained from a request for assessment of the SaaS product, a search for the product using a search engine, an input from a user, a predefined mapping of SaaS products to product URLs, etc.

At 310, a protocol name (also referred to as a compliant name) is obtained. The protocol name (or other identifier associated with the SaaS product) can be included in, or otherwise communicated in association with, a request for a SaaS product to be assessed.

At 315, a search engine is queried based at least in part on the product URL and the protocol name. For example, the system sends to a search engine a request for results pertaining to the product name and the protocol name. Although the example illustrated shows querying Microsoft® Bing, other search engines may be implemented (e.g., Google®, Yahoo! ®, DuckDuckGo, etc.) The system obtains a set of results in response to the query.

At 320, the product URL is used to obtain a webpage for the SaaS product.

At 325, information is obtained from the webpage for the SaaS product. In some embodiments, the system extracts HTML from the webpage for the SaaS product.

At 330, the HTML of the webpage for the SaaS product is obtained. In some embodiments, 330 and 325 are combined.

At 335, information is obtained from the HTML of the webpage for the SaaS product. In some embodiments, the system extracts body text from the HTML.

At 340, a set of results is obtained from the search engine. The set of results correspond to the query of 315. In response to receiving the results, the system filters the results to determine one or more relevant results (e.g., results that pertain to a description of the SaaS product vis a vis the protocol(s)). The system can filter the set of results to select one or more webpages deemed relevant for assessment of compliance with respect to the protocol. In some embodiments, the system selects the top result returned by the search engine (e.g., according to the search engine rankings).

In some embodiments, the system uses the webpage corresponding to the top result if the top result corresponds to a webpage under the same domain as the SaaS product or vendor for the SaaS product (e.g., the system deems the top result to be a relevant result). As an example, in the case of assessing whether Microsoft® Teams is compliant with a protocol, the system queries a search engine (e.g., Microsoft® Bing) and determines whether the top result returned by the search engine is a webpage under the domain www.microsoft.com, etc. In response to determining that the top result is a webpage under the domain for the SaaS product or vendor for the SaaS product, the system uses the webpage in connection with assessing the compliance/risk of the SaaS product. In some embodiments, the systems uses the most highly ranked result that matches a domain for the SaaS product or vendor thereof.

In some embodiments, in response to determining that the top result does not correspond to a webpage under the domain for the SaaS product or vendor thereof, the system uses a blank webpage in connection with querying a classifier for a determination/prediction compliance/risk for a SaaS product with respect to the one or more protocols. A blank webpage may be used in order to reduce/eliminate the risk of the classifier providing a false indication that the SaaS product is compliant. The blank webpage may be used in connection with the system inferring that the SaaS product is non-compliant based on the results returned by the search engine. As an example, if the search query of product identifier+protocol identifier returns results mostly relevant/matching the protocol identifier but not the conjunction of the product identifier and protocol identifier, webpages returned by such a query may include characteristics that are similar to those product webpages for compliant products. One particular example is that the top result for the search query may be a wiki webpage pertaining to the protocol (e.g., a webpage that does not particularly pertain to the SaaS product.

In some embodiments, the system determines the relevant webpages (e.g., webpages to use for assessing the compliance/risk of the SaaS product) based on selecting one or more of the most highly ranked results that are under the main domain for the SaaS product or vendor thereof. For example, the system selects a predetermined number of most highly ranked results (e.g., the two or three most highly ranked results, etc.) under the main domain. If the system uses multiple webpages (e.g., a plurality of the results returned by the query) in connection with assessing the compliance/risk of the SaaS product, the system obtains the links (e.g., URLs) for such webpages and combines all the webpages to form a single webpage to be provided to the classifier (e.g., the machine learning model).

At 345, information is obtained from the webpage(s) for the SaaS product that are filtered from the set of results returned by the search engine. In some embodiments, the system extracts HTML from the webpage(s) for the SaaS product that are deemed relevant (e.g., webpages that pertain to a description of the SaaS product vis a vis the protocol(s)).

At 350, the HTML of the webpage(s) for the SaaS product that are filtered from the set of results returned by the search engine is obtained. In some embodiments, 350 and 345 are combined.

At 355, information is obtained from the HTML of the webpage(s) for the SaaS product that are filtered from the set of results returned by the search engine. In some embodiments, the system extracts body text from the HTML.

At 360, 365, and 370, the system respectively obtains (i) the product name, (ii) body text from the webpage for the SaaS product (e.g., obtained at 335), and (iii) body text from the webpage(s) for the SaaS product that are filtered from the set of results returned by the search engine. The system provides such product name and body texts to a classifier for assessment of whether the SaaS product is compliant with the one or more protocols. In some embodiments, the system uses the information from 360, 365, and 370 to determine one or more feature vectors, or a combined feature vector to be provided to the classifier, etc.

At 375, the model is used to determine whether the SaaS product is compliant with the one or more protocols. For example, the system determines whether the SaaS product is compliant with the one or more protocols or a likelihood that the SaaS product is compliant with the one or more protocols. In some embodiments, the model determines whether the SaaS product is compliant with the one or more protocols based on analyzing (i) the product name, (ii) body text from the webpage for the SaaS product (e.g., obtained at 335), and (iii) body text from the webpage(s) for the SaaS product that are filtered from the set of results returned by the search engine. For example, the system can use one or more feature vectors in connection with querying a model for a prediction of whether the SaaS product is compliant with the one or more protocols.

At 380, an indication of whether the SaaS product is compliant with one or more protocols is provided. In some embodiments, the system provides the indication of whether the SaaS product is compliant (or a likelihood that the SaaS product is compliant) based at least in part on the analysis performed by the model.

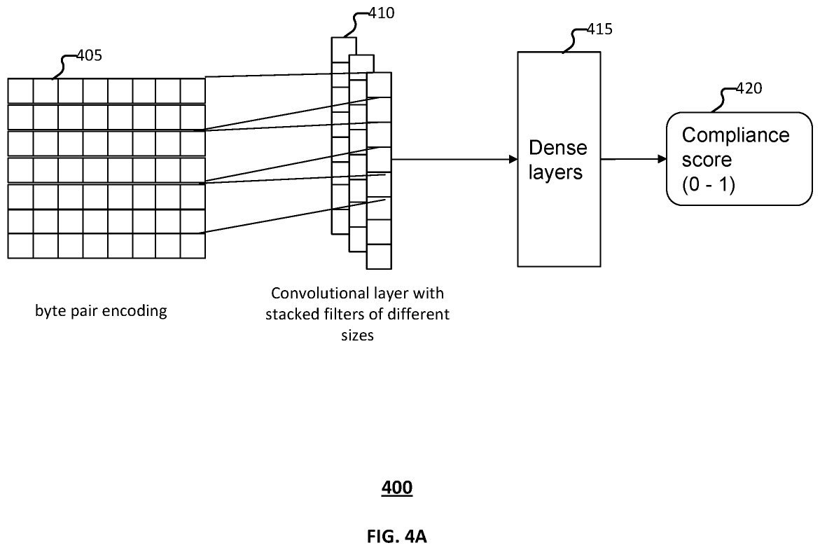

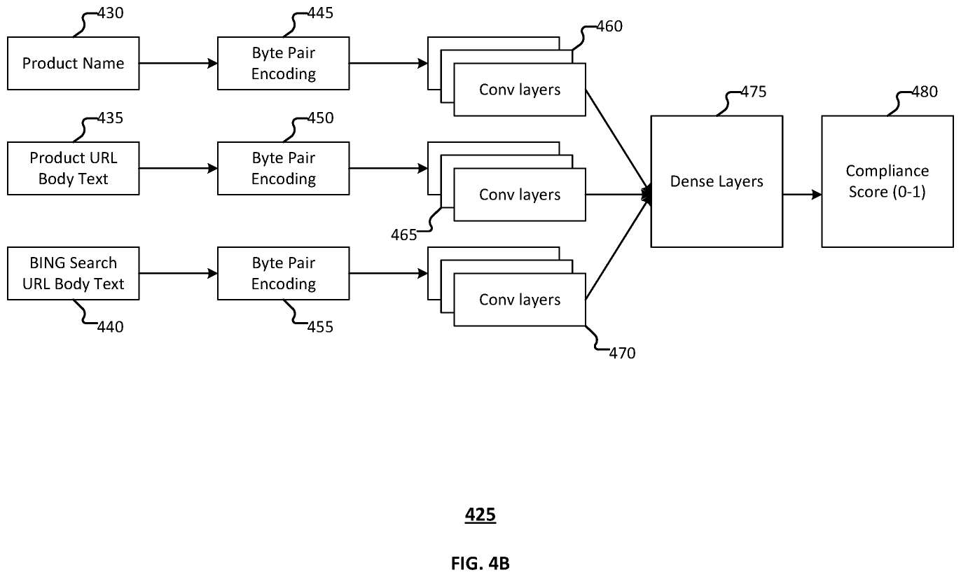

FIG. 4A is an illustration of a process for obtaining a compliance score with respect to compliance of a product with respect to one or more protocols according to various embodiments. In some embodiments, process 400 is at least partly implemented by system 100 of FIG. 1 or system 200 of FIG. 2.

At 405, the system performs byte-pair encoding with respect to information included on a webpage. For example, the system extracts body text from the webpage(s) pertaining to the SaaS product (e.g., a webpage returned by the search engine), and performs byte-pair encoding with respect to the body text. Byte-pair encoding is generally an efficient way to compress the data and is generally unsupervised. For example, byte-pair encoding is an efficient way to respectively represent n-grams having different lengths.

At 410, the output from the byte-pair encoding is filtered using one or more convolutional layers. For example, in response to byte-pair encoding the body text for the webpage(s) pertaining to the SaaS product, the system provides the byte-pair encoded body text to the convolutional layer(s). In some embodiments, the convolutional layer(s) comprises stacked filters of different sizes.

In the context of a convolutional neural network, a convolution is a linear operation that involves the multiplication of a set of weights with the input. The multiplication is performed between an array of input data and a two-dimensional array of weights, called a filter or a kernel.

A sentence of length n (e.g., n words) (padded where necessary) can be represented as Equation (1).

x_{1:n}=(x₁,x₂, . . . ,xₙ) (1)

A convolution operation applies to a window of h words to produce a new feature cᵢ, represented as Equation (2).

cᵢ=f(W·x_{1:h}) (2)

Here W is a linear filter and f is the rectified linear activation function (ReLU) function. According to various embodiments, the convolution goes over the sentence input with a sliding window to produce a feature map, represented as Equation (3).

c=(c₁,c₂, . . . ,cₙ₋ₕ₊₁) (3)

According to various embodiments, in the convolutional neural network, the model uses multiple filters (with varying window sizes) but the same number of filters to obtain multiple features. In some embodiments, the convolutional layer includes four different filter sizes 1, 3, 5, 7, and each sized filter can include 256 filters to produce the feature map. Various other filter sizes and/or numbers of filters can be implemented. In some embodiments, the feature map concatenated together.

Similarly, a feature map of length m can be represented as Equation (4).

c_{1:m}=(c₁,c₂, . . . ,cₘ) (4)

A convolution operation applies to a window of k features to produce a new feature dᵢ, represented in equation (5).

dᵢ=f(W′·c_{1:k}) (5)

fin Equation (5) is the ReLU function. In some embodiments, four different filter sizes 1, 3, 5, 7 are implemented, and each sized filter comprises 128 filters to produce the new feature maps. The resulting new feature maps can be concatenated together.

At 415, the information output from the convolutional layer is input to dense layers. In some embodiments, in response to concatenating the new feature maps, a max pooling operation is applied over a subset of the feature maps (e.g., the max pooling operation is performed with respect to two out of four feature maps). These features can form the penultimate layer and are passed to a fully connected layer comprising a number of filters of 1024. The resulting information is passed to another fully connected softmax layer comprising a number of filters of 256. In some embodiments, the softmax layer comprises an output corresponding to the probability distribution over labels.

At 420, the output from the dense layers (e.g., corresponding to the probability distribution over labels) is used to determine whether the SaaS product is compliant with the one or more protocols. For example, the system uses a model to analyze the probability distribution over labels to determine a prediction of whether the SaaS product is compliant with the one or more or more protocols. The system can determine a compliance score or a likelihood of whether the SaaS product is compliant with the one or more protocols.

FIG. 4B is an illustration of a process for obtaining a compliance score with respect to compliance of a product with respect to one or more protocols according to various embodiments. In some embodiments, process 425 is at least partly implemented by system 100 of FIG. 1 or system 200 of FIG. 2. In some embodiments, 425 implements process 400 with respect to (i) a product name, (ii) text from a webpage for the SaaS product, and (iii) text from a webpage obtained from querying a search engine using the product name and name(s) for the one or more protocols.

At 430, the product name is obtained. The product name can be a text string, an alphanumeric string, etc. The system can obtain the product name for a SaaS product based at least in part on a request to determine whether the SaaS product is compliant with one or more protocols.

At 435, information is obtained from a webpage for the SaaS product. In some embodiments, the system obtains (e.g., extracts) body text from the webpage for the SaaS product. As an example, the URL for the webpage for the SaaS product can be obtained from a request to determine whether the SaaS product is compliant with one or more protocols. As another example, the URL for the webpage for the SaaS product is obtained based on querying a search engine using the product name and/or a vendor name or identifier associated with the SaaS product.

At 440, information for a webpage pertaining to the SaaS product and one or more protocols is obtained. In some embodiments, the system queries a search engine using the product name and protocol(s) for which compliance is to be assessed. The system obtains the set of results from the search engine. In response to receiving the results, the system filters the results to determine one or more relevant results (e.g., results that pertain to a description of the SaaS product vis a vis the protocol(s)). The system can filter the set of results to select one or more webpages deemed relevant for assessment of compliance with respect to the protocol. In some embodiments, the system selects the top result returned by the search engine (e.g., according to the search engine rankings).

In some embodiments, the system uses the webpage corresponding to the top result if the top result corresponds to a webpage under the same domain as the SaaS product or vendor for the SaaS product (e.g., the system deems the top result to be a relevant result). As an example, in the case of assessing whether Microsoft® Teams is compliant with a protocol, the system queries a search engine (e.g., Microsoft® Bing) and determines whether the top result returned by the search engine is a webpage under the domain www.microsoft.com, etc. In response to determining that the top result is a webpage under the domain for the SaaS product or vendor for the SaaS product, the system uses the webpage in connection with assessing the compliance/risk of the SaaS product. In some embodiments, the systems uses the most highly ranked result that matches a domain for the SaaS product or vendor thereof.

At 445, byte pair embedding with respect to the product name. For example, the system performs 405 of process 400 of FIG. 4A with respect to the text of the product name (e.g., the alphanumeric string of the product name, etc.), such as the output of 430.

At 450, byte pair embedding with respect to the information obtained from a webpage for the SaaS product. For example, the system performs 405 of process 400 of FIG. 4A with respect to the body text obtained from the webpage for the SaaS, such as the output of 435.

At 455, byte pair embedding with respect to the information obtained from a webpage pertaining to the SaaS product and one or more protocols. For example, the system performs 405 of process 400 of FIG. 4A with respect to the body text obtained from the webpage for the SaaS product and one or more protocols, such as the output of 440.

At 460, the output from the byte-pair embedding is filtered using one or more convolutional layers. In some embodiments, the system filters the output of the byte pair embedding with respect to the product name (e.g., the output from 445). 460 can correspond to performing 410 of process 400 of FIG. 4A with respect to the output of the byte pair embedding of the product name.

At 465, the output from the byte-pair embedding is filtered using one or more convolutional layers. In some embodiments, the system filters the output of the byte pair embedding with respect to the information obtained from a webpage for the SaaS product (e.g., the output from 450). 465 can correspond to performing 410 of process 400 of FIG. 4A with respect to the output of the byte pair embedding of the information obtained from a webpage for the SaaS product.

At 470, the output from the byte-pair embedding is filtered using one or more convolutional layers. In some embodiments, the system filters the output of the byte pair embedding with respect to the information obtained from a webpage pertaining to the SaaS product and one or more protocols (e.g., the output from 455). 470 can correspond to performing 410 of process 400 of FIG. 4A with respect to the output of the byte pair embedding of the information obtained from a webpage pertaining to the SaaS product and one or more protocols.

At 475, the outputs of the filtering using various convolutional layers is input to dense layers. For example, the outputs of the filtering with respect to the byte-pair embedding of the product name, the byte-pair embedding of information obtained from a webpage for the SaaS product, and the byte-pair embedding of information obtained from a webpage pertaining to the SaaS product and one or more protocols. In some embodiments, the system performs 415 of process 400 of FIG. 4A with respect to the outputs from 460, 465, and 470.

At 480, the output from the dense layers 475 layers (e.g., corresponding to the probability distribution over labels) is used to determine whether the SaaS product is compliant with the one or more protocols. For example, the system uses a model to analyze the probability distribution over labels to determine a prediction of whether the SaaS product is compliant with the one or more or more protocols. The system can determine a compliance score or a likelihood of whether the SaaS product is compliant with the one or more protocols.

FIG. 5 is a flow diagram of a method for determining whether a product is compliant with one or more protocols according to various embodiments.

At 510, a URL for a webpage corresponding to a software-as-a-service (SaaS) product is determined. In some embodiments, the system determines the URL for the webpage corresponding to the SaaS product based at least in part on querying a search engine. For example, the system uses the product name and names or identifiers for the one or more protocols (e.g., a protocol(s) for which compliance of the SaaS product is to be assessed). In some embodiments, performing 510 includes performing one or more of 305, 310, 315, and/or 340 of process 300 of FIG. 3.

At 520, content from the webpage is extracted. In some embodiments, the system extracts body text from the webpage corresponding to the SaaS product. The extraction of the body text from the webpage can include performing 325, 330, and/or 335 of process 300 of FIG. 3. In some embodiments, the extraction of the content from the webpage includes performing 345, 350, and/or 355 of process 300 of FIG. 3.

At 530, at least the content is provided to a classifier. The system queries the classifier based at least on the content extracted from the webpage. In some embodiments, the system queries the classifier based on (i) the product name, (ii) information obtained from the webpage for the SaaS product, and/or (iii) information obtained from the webpage(s) pertaining to the SaaS product and the one or more protocols. In some embodiments, performing 530 includes performing 360, 365, 370, and/or 370 of process 300 of FIG. 3.

At 540, a determination of whether the SaaS product is compliant with one or more protocols is made. In some embodiments, performing 540 includes performing 380 of process 300 of FIG. 3. The system can use the classifier to analyze the content from the webpage in connection with determining whether the SaaS product is compliant with the one or more protocols (or likelihood of whether the SaaS product is compliant with the protocol(s)).

In response to determining that the SaaS product is determined to be compliant with the one or more protocols at 540, process 500 proceeds to 550 at which the SaaS product is handled as a compliant product. Handling the SaaS product as a compliant product can include permitting traffic to/from the SaaS product (e.g., permit traffic to/from a domain for the SaaS product). Handling the SaaS product as a compliant product can include providing an indication that the SaaS product to an enterprise (e.g., a customer for which the assessment of protocol compliance is performed), or to a client system attempting to access, or communicate information with, the SaaS product.

In response to determining that the SaaS product is determined to be compliant with the one or more protocols, the system can update a whitelist of SaaS products (e.g., a mapping of SaaS products to indicate that such SaaS products are benign, etc.).

In response to determining that the SaaS product is determined to be non-compliant with the one or more protocols at 540, process 500 proceeds to 560 at which the SaaS product is handled as a non-compliant product. Handling the SaaS product as a non-compliant product can include blocking traffic to/from the SaaS product, providing an indication that the SaaS product is non-compliant to a client system or enterprise for which assessment of protocol compliance is performed, etc.

In response to determining that the SaaS product is determined to be non-compliant with the one or more protocols, the system can update a blacklist of SaaS products (e.g., a mapping of SaaS products to indications that such SaaS products are non-compliant, etc.).

At 570, a determination is made as to whether process 500 is complete. In some embodiments, process 500 is determined to be complete in response to a determination that no further SaaS products are to be analyzed (e.g., no further predictions of whether a SaaS product is compliant with one or more protocols are to be performed), an administrator indicates that process 500 is to be paused or stopped, etc. In response to a determination that process 500 is complete, process 500 ends. In response to a determination that process 500 is not complete, process 500 returns to 510.

FIG. 6 is a flow diagram of a method for determining a risk score for a product based on compliance with one or more protocols according to various embodiments.

At 610, a URL for a webpage corresponding to a software-as-a-service (SaaS) product is determined. In some embodiments, the system determines the URL for the webpage corresponding to the SaaS product based at least in part on querying a search engine. For example, the system uses the product name and names or identifiers for the one or more protocols (e.g., a protocol(s) for which compliance of the SaaS product is to be assessed). In some embodiments, performing 510 includes performing one or more of 305, 310, 315, and/or 340 of process 300 of FIG. 3.

At 620, content from the webpage is extracted. In some embodiments, the system extracts body text from the webpage corresponding to the SaaS product. In some embodiments, the extraction of the content from the webpage includes performing 345, 350, and/or 355 of process 300 of FIG. 3.

At 630, at least the content is provided to a classifier. The system queries the classifier based at least on the content extracted from the webpage. In some embodiments, the system queries the classifier based on (i) the product name, (ii) information obtained from the webpage for the SaaS product, and/or (iii) information obtained from the webpage(s) pertaining to the SaaS product and the one or more protocols. In some embodiments, performing 630 includes performing 360, 365, and/or 370 of process 300 of FIG. 3.

At 640, a result from analyzing the content with the classifier is used to determine a risk score for the SaaS product. The system can determine the risk score based on a result of using the classifier to analyze the SaaS product. For example, in response to receiving a result of analysis of the SaaS product (e.g., the body text for the webpage pertaining to the SaaS product), the system determines a risk score for the SaaS product. As another example, the result of the analysis of the SaaS product is a risk score (e.g., the classifier determines the risk score).

At 650, an indication of the risk score for the SaaS product is provided. In some embodiments, the system provides an indication of the risk score to a security entity, a client system, or enterprise such as a customer for which the assessment of whether the SaaS product is compliant or a risk score of the SaaS product. In some embodiments, the risk score is an aggregated score pertaining to an enterprise risk of a set of SaaS products, etc.

At 660, a determination is made as to whether process 600 is complete. In some embodiments, process 600 is determined to be complete in response to a determination that no further SaaS products are to be analyzed (e.g., no further predictions of whether a SaaS product is compliant with one or more protocols are to be performed, no further risk assessments for a SaaS product are to be performed, etc.), an administrator indicates that process 600 is to be paused or stopped, etc. In response to a determination that process 600 is complete, process 600 ends. In response to a determination that process 600 is not complete, process 600 returns to 610.

FIG. 7 is a flow diagram of a method for determining a model for detecting whether a product is compliant with one or more protocols according to various embodiments.

At 710, training data is obtained. In some embodiments, the training data includes a set of webpages (or content for the webpages) for SaaS products deemed compliant with respect to a protocol(s) and/or a set of webpages (or content for the webpages) for SaaS products deemed non-compliant. The training data can correspond to data that is labeled to indicate whether a SaaS product is compliant/non-compliant (e.g., data that was previously manually labeled by a human, etc.).

At 720, label data is generated. In some embodiments, the system determines the label data based at least in part on the training data. As an example, the system determines patterns, attributes, characteristics, etc. that are generally indicative of whether the SaaS product is compliant (or non-compliant).

At 730, a model is trained based on the label data. In some embodiments, the model is trained in accordance with CNN neural network models training processes.

In some embodiments, the model is trained using a machine learning process. For example, the machine learning model can be trained based on n-grams (e.g., n-grams used in determining features to train the model). Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc. In some embodiments, the model is trained using an CNN classifier model. Inputs to the classifier (e.g., the CNN classifier model) are a combined feature vector or set of feature vectors and based on the combined feature vector or set of feature vectors, the classifier model determines whether the corresponding sample is malicious, or a likelihood that the sample is malicious. The combined feature vector or set of feature vectors can be based at least in part on a set of signature count features. For example, the combined feature vector or set of feature vectors are based on (i) a set of HTML, and HAR features, and (ii) a set of signature count features.

In some embodiments, a different model is trained for determining compliance with respect to different protocol. For example, a model can be used in connection with determining whether a single SaaS product is compliant with the protocol (e.g., each model corresponds to a single protocol for which compliance is to be assessed).

At 740, the model is deployed. In some embodiments, deploying the model includes storing the model in a dataset of models for use in connection with analyzing webpages pertaining to a SaaS product to determine whether the SaaS product is compliant with one or more protocols. In some embodiments, deploying the model includes storing the model in a dataset of models for use in connection with analyzing compliance of SaaS products (or content for webpages pertaining to the SaaS product and one or more protocols) to determine whether the SaaS product is compliant. The deploying the model can include providing the model (or a location at which the model can be invoked) to a SaaS product risk assessor, such as SaaS product risk assessor 170 of system 100 of FIG. 1, or to system 200 of FIG. 2. In some embodiments, the model is provided to a security entity such as a firewall, etc. for an in-line detection of whether requests are directed to domains corresponding to non-compliant SaaS products.

At 760, a determination is made as to whether process 700 is complete. In some embodiments, process 700 is determined to be complete in response to a determination that no further models are to be updated (e.g., no further classifiers for predicting whether a SaaS product is compliant with one or more protocols or for predicting risk assessments for a SaaS product are to be performed, etc.), no further updates are to be made to the model, an administrator indicates that process 700 is to be paused or stopped, etc. In response to a determination that process 700 is complete, process 700 ends. In response to a determination that process 700 is not complete, process 700 returns to 710.

FIG. 8 is a flow diagram of a method for determining a risk score for a product based on compliance with one or more protocols according to various embodiments.

At 810, a set of webpages corresponding to a SaaS product is obtained. The set of webpages corresponding to the SaaS product can correspond to webpages deemed relevant by the system or a search engine. In some embodiments, the system determines the set of webpages corresponding to the SaaS product based at least in part on querying a search engine. For example, the system uses the product name and names or identifiers for the one or more protocols (e.g., a protocol(s) for which compliance of the SaaS product is to be assessed). For example, the system sends a query to a search engine (e.g., Microsoft® Bing, Google®, Yahoo! ®, DuckDuckGo, etc.) for the SaaS protocol. The query can include an indication of the SaaS product (e.g., a product name, product URL, a product version, domain of product or service provider, etc.) and at least one of the protocols with which compliance is to be assessed. The system can use a set of queries respectively corresponding to different protocols to discover webpages pertaining to the SaaS product compliance with respect to the different protocol. The system receives a set of results for the query to the search engine. The set of results includes a set of URLs for various webpages.

In some embodiments, in response to receiving the set of results for the query to the search engine, the system filters the set of results to obtain a relevant webpage(s). The system can determine the relevant webpages (e.g., webpages to use for assessing the compliance/risk of the SaaS product) based on selecting one or more of the most highly ranked results that are under the main domain for the SaaS product or vendor thereof. For example, the system selects a predetermined number of most highly ranked results (e.g., the two or three most highly ranked results, etc.) under the main domain. If the system uses multiple webpages (e.g., a plurality of the results returned by the query) in connection with assessing the compliance/risk of the SaaS product, the system obtains the links (e.g., URLs) for such webpages and combines all the webpages to form a single webpage to be provided to the classifier (e.g., the model).

At 820, HTML is extracted from the set of webpages. In some embodiments, the extraction of the content from the webpage includes performing 345 of process 300 of FIG. 3.

At 830, at least a body text comprised in the HTML for the set of webpages is tokenized. The system can extract the body text comprised in the HTML based on performing 355 of process 300 of FIG. 3. In response to extracting the body text, the body text is tokenized.

At 840, a product name and the tokenized body text for the set of webpages is provided to a classifier. The system queries the classifier using the product name and the tokenized body text for the set of webpages. For example, performing 840 includes performing 360, 365, 370, and/or 375 of process 300 of FIG. 3.

At 850, the classifier is used to analyze the product name and the tokenized body text for the set of webpages. The classifier analyzes the product name and the tokenized body in connection with determining whether, or a likelihood of whether, the SaaS product is compliant with the one or more protocols.

At 860, a risk score is obtained for the SaaS product based on a result of the analysis by the classifier. As an example, the risk score can correspond to the likelihood of whether the SaaS product is compliant with the one or more protocols. As an example, the risk score is determined according to a predefined formula or process. The system can aggregate risk scores for a set of SaaS products (e.g., SaaS products for which traffic is detected across a network or to an endpoint) to determine an aggregated risk score indicating an enterprise risk to the organization associated with the network or endpoints.

At 870, a determination is made as to whether process 800 is complete. In some embodiments, process 800 is determined to be complete in response to a determination that no further SaaS products are to be analyzed (e.g., no further predictions of whether a SaaS product is compliant with one or more protocols are to be performed, no further risk assessments for a SaaS product are to be performed, etc.), an administrator indicates that process 800 is to be paused or stopped, etc. In response to a determination that process 800 is complete, process 800 ends. In response to a determination that process 800 is not complete, process 800 returns to 810.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
determine a URL of a webpage for a software-as-a-service (SaaS) product;
extract body text from the webpage; and
use a classifier to determine whether the SaaS product is compliant with one or more protocols based at least in part on the body text; and
a memory coupled to the one or more processors and configured to provide the one or more processors with instructions.

2. The system of claim 1, wherein the classifier is a machine learning model.

3. The system of claim 1, wherein the one or more processors are further configured to:
provide, to a client system, an indication that indicates whether the SaaS product is compliant with the one or more protocols.

4. The system of claim 1, wherein the one or more processors are further configured to:
determine one or more risk scores based at least in part on a determination of whether the SaaS product is compliant with one or more protocols based at least in part on the body text.

5. The system of claim 4, wherein using the classifier to determine whether the SaaS product is compliant with the one or more protocol comprises:
determining, for a set of a plurality of SaaS products, whether each SaaS product in the plurality of SaaS products is compliant with at least a subset of the one or more protocols.

6. The system of claim 5, wherein the one or more risk scores includes an aggregate score indicating a security of the set of the plurality of SaaS products.

7. The system of claim 5, wherein the one or more risk scores comprises a plurality of scores respectively corresponding to the plurality of SaaS products.

8. The system of claim 1, wherein using the classifier to determine whether the SaaS product is compliant with the one or more protocol comprises:
inputting at least the body text to the classifier; and
determining whether the SaaS product is compliant with the one or more protocols based at least in part on the classifier.

9. The system of claim 1, wherein a product name for the SaaS product is extracted from the webpage, and the product name and the body text are input to the classifier in connection with determining whether the SaaS product is compliant with one or more protocols.

10. The system of claim 1, wherein the one or more protocols include one or more of (i) General Data Protection Regulation (GDPR), (ii) Health Insurance Portability and Accountability Act (HIPAA), (iii) International Traffic in Arms Regulations (ITAR), (iv) ISO 9001, and (v) Financial Industry Regulatory Authority (FINRA).

11. The system of claim 1, wherein the URL of the webpage is obtained from a search engine.

12. The system of claim 1, wherein the one or more processors are further configured to:
request a link to a webpage using a search engine;
obtain results from the search engine, the results comprising a plurality of resultant is webpages; and
filter the plurality of resultant webpages to obtain the webpage.

13. The system of claim 12, wherein the webpage is obtained by selecting a first search result for the plurality of results webpages.

14. The system of claim 12, wherein filtering the plurality of webpages to obtain the webpage comprises:
obtaining a plurality of pages;
generating a page map; and
combining relevant pages to obtain the webpage.

15. The system of claim 1, wherein the one or more processors are further configured to:
determine a risk score based at least in part on the use of classifier to determine whether the SaaS product is compliant with one or more protocols based at least in part on the body text; and
in response to determining that the risk score exceeds a predefined risk threshold, cause a security policy to be enforced.

16. The system of claim 1, wherein:
a risk score is determined based at least in part on the use of classifier to determine whether the SaaS product is compliant with one or more protocols based at least in part on the body text; and
a security entity enforces a security policy in response to a determination that the risk score exceeds a predefined risk threshold.

17. The system of claim 16, wherein enforcing the security policy comprises restricting access to the SaaS product by one or more client terminals.

18. The system of claim 1, wherein the classifier comprises a Convolutional Neural Network (CNN) model, and the CNN is used to perform text classification with respect to the body text.

19. A method, comprising:
determining, by one or more processors, a URL of a webpage for a software-as-a-service (SaaS) product;
extracting body text from the webpage; and
is using a classifier to determine whether the SaaS product is compliant with one or more protocols.

20. A computer program product embodied in a non-transitory computer readable medium and comprising computer instructions for:
determining, by one or more processors, a URL of a webpage for a software-as-a-service (SaaS) product;
extracting body text from the webpage; and
using a classifier to determine whether the SaaS product is compliant with one or more protocols.

21. A system, comprising:
one or more processors configured to:
generate label data for training a machine learning model to detect software-as-a-service (SaaS) product compliance with one or more protocols;
train the machine learning model based at least in part on the label data; and
deploy the machine learning model; and
a memory coupled to the one or more processors and configured to provide the one or more processors with instructions.
